(19) United States
(12) Patent Application Publication
(10) Pub. No.: US 2025/0115788 A1
(43) Pub. Date: Apr. 10, 2025

(54) TWO COMPONENT (2K) CURABLE ADHESIVE COMPOSITION

(71) Applicant: Henkel AG & Co. KGaA, Duesseldorf (DE)

(72) Inventors: Stefanie Stapf, Essen (DE); Alexandra Lieske, Duesseldorf (DE); Thomas Kamm, Leverkusen (DE); Ruediger Butterbach, Essen (DE); Uta Sundermeier, Leichlingen (DE); Kang Wei Chou, Duesseldorf (DE)

(21) Appl. No.: 18/984,384

(22) Filed: Dec. 17, 2024

Related U.S. Application Data
(63) Continuation of application No. PCT/EP2023/063177, filed on May 18, 2023.

(30) Foreign Application Priority Data
Jun. 17, 2022 (EP) 22179603.0

(51) Int. Cl. C09J 4/06; B32B 7/06; B32B 7/12; B32B 15/04; B32B 15/18; B32B 43/00; C09J 5/00; C09J 9/02; C09J 11/06; C09J 11/08; C09J 133/06; C09J 133/14

(52) U.S. Cl. CPC C09J 4/06; B32B 7/06; B32B 7/12; B32B 15/043; B32B 15/18; B32B 43/006; C09J 5/00; C09J 9/02; C09J 11/06; C09J 11/08; C09J 133/064; C09J 133/14; B32B 2255/06; B32B 2255/26; B32B 2307/202; B32B 2307/542; B32B 2307/748; B32B 2310/021; B32B 2311/30

(57) ABSTRACT

The present invention is directed to a curable and debondable two-part (2K) adhesive composition comprising: i) a first part comprising: (meth)acrylate monomer; co-polymerizable acid; and, an electrolyte; and, ii) a second part comprising: a first curing agent for the monomers of said first part; a second curing agent for the monomers of said first part; a wax; and, a solubilizer, wherein said two-part (2K) adhesive composition further comprises a toughener, an oxygen scavenger and a rheology control agent and further wherein said two-part (2K) adhesive composition is characterized in that said electrolyte comprises or consists of at least one salt in accordance with Formula (I) or Formula (II):

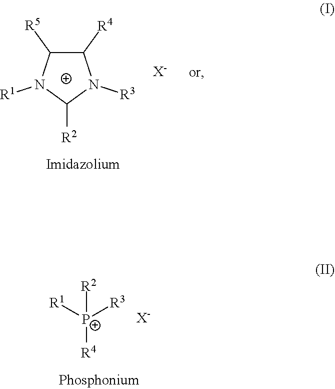

### FIELD OF THE INVENTION

The present invention is directed to an adhesive composition which can be debonded from particular substrates to which it is applied. More particularly, the present invention is directed to a two-part (2K) curable and debondable adhesive composition which has particular utility in the bonding of electronic components.

### BACKGROUND TO THE INVENTION

Adhesive bonds and polymeric coatings are commonly used in the assembly and finishing of manufactured goods. They are used in place of mechanical fasteners, such as screws, bolts and rivets, to provide bonds with reduced machining costs and greater adaptability in the manufacturing process. Adhesive bonds distribute stresses evenly, reduce the possibility of fatigue and seal the joints from corrosive species.

Whilst adhesive bonds thus offer many advantages over mechanical fasteners, it tends to be difficult to disassemble adhesively bonded objects where this is required in practical applications. The removal of the adhesive through mechanical processes—such as by sand blasting or by wire brushing—is often precluded, in part because the adhesive is disposed between substrates and is thus either inaccessible or difficult to abrade without corrupting the substrate surfaces. Disassembly through the application of chemicals and/or high temperature—such as disclosed in U.S. Pat. No. 4,171,240 (Wong), U.S. Pat. No. 4,729,797 (Linde et al.) and US 20140287299 A1 (Krogdahl)—might be effective but can be time consuming and complex to perform: moreover, the aggressive chemicals and/or harsh conditions required can damage the substrates being separated, rendering them unsuitable for subsequent applications.

As an exemplary case, it is evidently desirable to remove, replace and/or recycle the components of electronic devices—such as personal computers, laptops and tablets—which have been attached within the devices using adhesives. However, such adhesives are typically strong in that they are designed to maintain adhesion both during drop or impact events and across a wide range of operating temperatures and other environmental conditions. If care is not taken, adhesive-bonded device components can therefore be damaged or destroyed when removing the components through mechanical processes, the application of chemicals or high temperature.

Noting these problems, certain authors have sought to develop debondable adhesive compositions, wherein the passage of an electrical current through the cured compositions acts to disrupt the bonding at the interface of the adhesive and the substrate.

U.S. Pat. No. 7,465,492 (Gilbert) describes an disbondable composition comprising: a matrix functionality comprising a monomer selected from the group consisting of acrylics, methacrylics and combinations thereof; a free radical initiator; and, an electrolyte, wherein the electrolyte provides sufficient ionic conductivity to said composition to support a faradaic reaction at a bond formed between the composition and an electrically conductive surface and thus allows the composition to disbond from the surface.

US 2007/0269659 (Gilbert) describes an adhesive composition disbondable at two interfaces, the composition: (i) comprising a polymer and an electrolyte; (ii) facilitating joinder of two surfaces; and, (iii) in response to a voltage applied across both surfaces so as to form an anodic interface and a cathodic interface, disbonding from both the anodic and cathodic surfaces.

US 2008/0196828 (Gilbert) describes a hot-melt adhesive composition comprising: a thermoplastic component; and, an electrolyte, wherein the electrolyte provides sufficient ionic conductivity to the composition to enable a faradaic reaction at a bond formed between the composition and an electrically conductive surface and to allow the composition to disbond from the surface.

WO2017/133864 (Henkel AG & Co. KGaA) describes a method for reversibly bonding a first and a second substrate, wherein at least the first substrate is an electrically non-conductive substrate, the method comprising: a) coating the surface of the electrically non-conductive substrate(s) with a conductive ink; b) applying an electrically debondable hot melt adhesive composition to the conductive ink-coated surface of the first substrate and/or the second substrate; c) contacting the first and the second substrates such that the electrically debondable hot melt adhesive composition is interposed between the two substrates; d) allowing formation of an adhesive bond between the two substrates to provide bonded substrates; and, e) applying a voltage to the bonded substrates whereby adhesion at least one interface between the electrically debondable hot melt adhesive composition and a substrate surface is substantially weakened.

EP 3835381 A1 (Henkel AG & Co. KGaA) describes a curable and debondable two-part (2K) adhesive composition comprising: i) a first part comprising: (meth)acrylate monomer; co-polymerizable acid; and, an electrolyte; and, ii) a second part comprising: a first curing agent for the monomers of said first part; a second curing agent for the monomers of said first part; and, a solubilizer.

There remains a need in the art to provide an adhesive composition which can be conveniently applied to the surfaces of substrates to be bonded, which upon curing thereof can provide an effective bond within composite structures containing said substrates but which can be effectively de-bonded from those substrates by the facile application of an electrical potential across the cured adhesive. In particular, the present inventors have recognized a need in the art to develop debondable adhesives which can be applied to the surfaces of substrates to be bonded without deterioration of the bond within the composite structure when those substrates are exposed to high humidity and high temperature conditions. Such debondable adhesives would have advantageous utility in inter alia electronic devices.

### STATEMENT OF THE INVENTION

In accordance with a first aspect of the invention there is provided a curable and debondable two-part (2K) adhesive composition comprising:
a first part (A) comprising:
   (meth)acrylate monomer;
   co-polymerizable acid; and,
   an electrolyte; and,
a second part (B) comprising:
   a first curing agent for the monomers of said first part;
   a second curing agent for the monomers of said first part;
   a wax; and,
   a solubilizer,
      wherein said two-part (2K) adhesive composition further comprises:
a toughener;
an oxygen scavenger; and,
a rheology control agent;
   further wherein said two-part (2K) adhesive composition is characterized in that said electrolyte comprises or consists of at least one salt in accordance with Formula (I) or Formula (II):

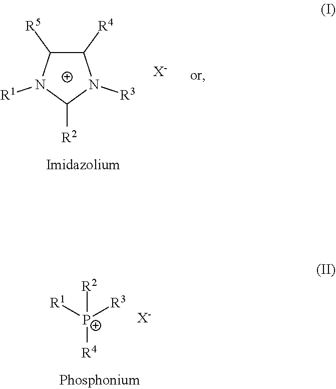

wherein: R¹, R², R³, R⁴ and R⁵ are independently selected from hydrogen, C₁-C₁₈ alkyl, C₃-C₁₈ cycloalkyl, C₆-C₁₈ aryl, C₇-C₂₄ aralkyl, C₂-C₂₀ alkenyl, —C(O)R^{q}, —C(O)OH, —CN or —NO₂; and, R^{q} is C₁-C₆ alkyl; and, X⁻ is a counter anion selected from the group consisting of:

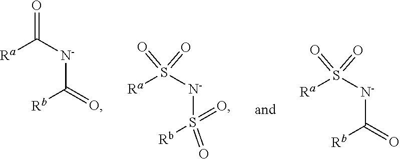

in which formulae R^{a} and R^{b} are independently selected from hydrogen, C₁-C₁₂ alkyl, C₅-C₁₂ cycloalkyl, C₅-C₁₂ heterocycloalkyl, C₆-C₁₈ aryl or C₅-C₁₈ heteroaryl.

The toughener, oxygen scavenger and rheology control agent may be included in one or both of the parts of the composition. However, it is preferred that the first component of the composition, comprising the reactive monomers, also comprises said toughener, oxygen scavenger and rheology control agent.

In important embodiments of the invention, the two part-part adhesive composition comprises:
a first part (A) comprising, based on the weight of said first part:
   from 20 to 80 wt. %, preferably from 30 to 60 wt. %, of said (meth)acrylate monomer;
   from 0.5 to 20 wt. %, preferably from 5 to 15 wt. %, of said co-polymerizable acid; and,
   from 0.5 to 20 wt. %, preferably from 5 to 15 wt. %, of said electrolyte; and,
a second part (B) comprising, based on the weight of said second part:
   from 5 to 40 wt. %, preferably from 10 to 40 wt. % of said first curing agent;
   from 0.01 to 2 wt. %, preferably from 0.01 to 1 wt. % of said second curing agent;
   from 5 to 30 wt. %, preferably from 5 to 20 wt. % of said wax; and,
   from 20 to 60 wt. %, preferably from 30 to 60 wt. % of said solubilizer,
      wherein said composition further comprises, based on the total weight of the composition:
from 5 to 40 wt. %, preferably from 10 to 40 wt. % of said toughener;
from 0.1 to 5 wt. %, preferably from 0.1 to 2 wt. % of said oxygen scavenger; and,
from 1 to 20 wt. % of said rheology control agent.

The first (A) and second (B) parts are conventionally combined at a ratio by weight of A:B of from 20:1 to 1:1, for example 15:1 to 5:1 or from 12:1 to 8:1. A particularly preferred embodiment of the composition has a ratio by weight of Part A:Part B of 10:1.

Compositions in accordance with these definitions have been demonstrated to provide excellent bond stability under high temperature and high humidity conditions, the examples below documenting stability at inter alia 95% relative humidity (RH) and 65° C. Moreover, when composite structures have been formed using the cured adhesive compositions, these structures have been facile to debond by the application of a potential difference across the adhesive bond.

In the first part of the adhesive composition, said co-polymerizable acid is preferably selected from the group consisting of methacrylic acid, acrylic acid, itaconic acid, maleic acid, aconitic acid, crotonic acid, fumaric acid and mixtures thereof: a particular preference for methacrylic acid is noted.

Independently of or additional to this statement of preference for the co-polymerizable acid of said first part, said electrolyte is preferably selected from the group consisting of: 1-methylimidazolium bis(trifluoromethylsulfonyl)imide; 3-methylimidazolium bis(trifluoromethylsulfonyl) imide; 1-ethyl-3-methylimidazolium bis(trifluoromethylsulfonyl)imide; 1-propyl-3-methylimidazolium bis(trifluoromethylsulfonyl)imide; 1-butyl-3-methylimidazolium bis(trifluoromethylsulfonyl)imide; 1-butyl-2,3-dimethylimidazolium bis(trifluoromethylsulfonyl) imide; 1-hexyl-3-methylimidazolium bis(trifluoromethylsulfonyl)imide; 1-octyl-3-methylimidazolium bis(trifluoromethylsulfonyl)imide; 1-methyl-3-octylimidazolium bis(trifluoromethylsulfonyl)imide; 1-decyl-3-methylimidazolium bis(trifluoromethylsulfonyl)imide; 1-dodecyl-3-methylimidazolium bis(trifluoromethylsulfonyl)imide; tetraethylphosphonium bis(trifluoromethylsulfonyl)imide; tetrabutylphosphonium bis(trifluoromethylsulfonyl)imide; tridecyl(tetradecyl)phosphonium bis(trifluoromethylsulfonyl)imide; and, mixtures thereof. A particular preference for the use of at least one of 1-butyl-3-methylimidazolium bis(trifluoromethylsulfonyl)imide and 1-dodecyl-3-methylimidazolium bis(trifluoromethylsulfonyl)imide may be mentioned.

In the second part of the adhesive composition, it is preferred that said first curing agent is a peroxide curing agent preferably selected from the group consisting of tert-butyl peroxide, tert-butyl perbenzoate, cumene hydroperoxide, tert-butyl peroxybenzoate, diacetyl peroxide, benzoyl peroxide, tert-butyl peracetate, lauryl peroxide and mixtures thereof: the use of benzoyl peroxide is particularly preferred.

Independently of or additional to this statement of preference for the first curing agent, said second curing agent preferably consists of at least one compound which is either a salt or a complex of a transition metal selected from the group consisting of Fe, Co, V, Mn and Cu. More preferably, the second curing agent comprises or consists of at least one iron-based compound selected from the group consisting of ferrocene, iron(II) acetylacetonate and ammonium iron(3+) hexakis(cyano-C)ferrate(4−).

Independently of or additional to the statements of preference for the first and second curing agents, it is preferred that the solubilizer of the second part of the adhesive composition is either polyalkylene glycol or epoxy resin selected from the group consisting of cycloaliphatic epoxides, epoxy novolac resins, bisphenol-A-epoxy resins, bisphenol-F-epoxy resins, bisphenol-A epichlorohydrin based epoxy resins, alkyl epoxides, limonene dioxides, polyepoxides and mixtures thereof: a particular preference for solubilizer comprising or consisting of bisphenol-A epoxy resin is noted.

In accordance with a second aspect of the invention, there is provided a bonded structure comprising:
a first material layer having an electrically conductive surface; and,
a second material layer having an electrically conductive surface,
   wherein the cured debondable two-part (2K) adhesive composition as defined hereinabove and in the appended claims is disposed between said first and second material layers.

In accordance with a third aspect of the present invention, there is provided a method of debonding said bonded structure as defined hereinabove and in the appended claims, the method comprising the steps of:
i) applying a voltage across both surfaces to form an anodic interface and a cathodic interface; and,
ii) debonding the surfaces.

Step i) of this method is preferably characterized by at least one of:
a) an applied voltage of from 0.5 to 100 V; and,
b) the voltage being applied for a duration of from 1 second to 60 minutes.

### Definitions

As used herein, the singular forms “a”, “an” and “the” include plural referents unless the context clearly dictates otherwise.

The terms “comprising”, “comprises” and “comprised of” as used herein are synonymous with “including”, “includes”, “containing” or “contains”, and are inclusive or open-ended and do not exclude additional, non-recited members, elements or method steps.

As used herein, the term “consisting of” excludes any element, ingredient, member or method step not specified.

When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

Further, in accordance with standard understanding, a weight range represented as being “from 0 to x” specifically includes 0 wt. %: the ingredient defined by said range may be absent from the composition or may be present in the composition in an amount up to x wt. %.

The words “preferred”, “preferably”, “desirably” and “particularly” are used frequently herein to refer to embodiments of the disclosure that may afford particular benefits, under certain circumstances. However, the recitation of one or more preferable, preferred, desirable or particular embodiments does not imply that other embodiments are not useful and is not intended to exclude those other embodiments from the scope of the disclosure.

As used throughout this application, the word “may” is used in a permissive sense—that is meaning to have the potential to—rather than in the mandatory sense.

As used herein, room temperature is 23° C. plus or minus 2° C. As used herein. “ambient conditions” means the temperature and pressure of the surroundings in which the composition is located or in which a coating layer or the substrate of said coating layer is located.

“Two-part (2K) compositions” in the context of the present invention are understood to be compositions in which a first part (A) and a second part (B) must be stored in separate vessels because of their (high) reactivity. The two parts are mixed only shortly before application and then react, typically without additional activation, with bond formation and thereby formation of a polymeric network. Herein higher temperatures may be applied in order to accelerate the cross-linking reaction.

As used herein the term “debondable” means that, after curing of the adhesive, the bond strength can be weakened by at least 50% upon application of an electrical potential of from 5V-75V for a duration of from 1 s to 60 minutes. The cured adhesive is applied between two substrates which are bonded by said adhesive so that an electric current is running through the adhesive bond line. Bond strength is measured by Tensile Lap Shear (TLS) test performed at room temperature and based upon EN 1465:2009 (German version) Based on Adhesives—Determination of tensile lap-shear strength of bonded assemblies.

As used herein, the term “monomer” refers to a substance that can undergo a polymerization reaction to contribute constitutional units to the chemical structure of a polymer. The term “monofunctional”, as used herein, refers to the possession of one polymerizable moiety. The term “polyfunctional”, as used herein, refers to the possession of more than one polymerizable moiety.

As used herein, the term “equivalent (eq.”) relates, as is usual in chemical notation, to the relative number of reactive groups present in the reaction.

The term “electrolyte” is used herein in accordance with its standard meaning in the art as a substance containing free ions which can conduct electricity by displacement of charged carrier species. The term is intended to encompass molten electrolytes, liquid electrolytes, semi-solid electrolytes and solid electrolytes wherein at least one of the cationic or anionic components of their electrolyte structure is essentially free for displacement, thus acting as charge carrier.

The curable adhesive compositions of the present invention and the cured adhesives obtained therefrom possess “electrolyte functionality” in that the adhesive material permits the conduction of ions, either anions, cations or both. The electrolyte functionality is understood to derive from the ability of the compositions and cured adhesives to solvate ions of at least one polarity.

As used herein, “(meth)acryl” is a shorthand term referring to “acryl” and/or “methacryl”. Thus, the term “(meth)acrylamide” refers collectively to acrylamide and methacrylamide.

As used herein, “C₁-Cₙ alkyl” group refers to a monovalent group that contains 1 to n carbons atoms, that is a radical of an alkane and includes straight-chain and branched organic groups. As such, a “C₁-C₁₈ alkyl” group refers to a monovalent group that contains from 1 to 18 carbons atoms, that is a radical of an alkane and includes straight-chain and branched organic groups. In general, a preference for alkyl groups containing from 1-12 carbon atoms (C₁-C₁₂ alkyl)—for example alkyl groups containing from 1 to 8 carbon atoms (C₁-C₈ alkyl)—should be noted. Examples of alkyl groups include, but are not limited to: methyl; ethyl; propyl; isopropyl; n-butyl; isobutyl; sec-butyl; tert-butyl; n-pentyl; n-hexyl; n-heptyl; and, 2-ethylhexyl. In the present invention, such alkyl groups may be unsubstituted or may be substituted with one or more halogen. Where applicable for a given moiety (R), a tolerance for one or more non-halogen substituents within an alkyl group will be noted in the specification.

The term “C₁-C₁₈ hydroxyalkyl” as used herein refers to a HO-(alkyl) group having from 1 to 18 carbon atoms, where the point of attachment of the substituent is through the oxygen-atom and the alkyl group is as defined above.

An “alkoxygroup” refers to a monovalent group represented by —OA where A is an alkyl group: non-limiting examples thereof are a methoxy group, an ethoxy group and an iso-propyloxy group. The term “C₁-C₁₈ alkoxyalkyl” as used herein refers to an alkyl group having an alkoxy substituent as defined above and wherein the moiety (alkyl-O-alkyl) comprises in total from 1 to 18 carbon atoms: such groups include methoxymethyl (—CH₂OCH₃), 2-methoxyethyl (—CH₂CH₂OCH₃) and 2-ethoxyethyl. Analogously, the term “C₇-C₁₈ alkoxyaryl” as used herein refers to an aryl group having an alkoxy substituent as defined above and wherein the moiety (aryl-O-alkyl) has in total from 7 to 18 carbon atoms.

The term “C₂-C₄ alkylene” as used herein, is defined as saturated, divalent hydrocarbon radical having from 2 to 4 carbon atoms.

The term “C₅-C₁₈ cycloalkyl” is understood to mean a saturated, mono- or polycyclic hydrocarbon group having from 3 to 18 carbon atoms. In the present invention, such cycloalkyl groups may be unsubstituted or may be substituted with one or more halogen. Where applicable for a given moiety (R), a tolerance for one or more non-halogen substituents within a cycloalkyl group will be noted in the specification. Examples of cycloalkyl groups include: cyclopropyl; cyclobutyl; cyclopentyl; cyclohexyl; cycloheptyl; cyclooctyl; adamantane; and, norbornane.

As used herein, an “C₆-C₁₈ aryl” group used alone or as part of a larger moiety—as in “aralkylgroup”—refers to monocyclic, bicyclic and tricyclic ring systems in which the monocyclic ring system is aromatic or at least one of the rings in a bicyclic or tricyclic ring system is aromatic. The bicyclic and tricyclic ring systems include benzofused 2-3 membered carbocyclic rings. In the present invention, such aryl groups may be unsubstituted or may be substituted with one or more halogen. Where applicable for a given moiety (R), a tolerance for one or more non-halogen substituents within an aryl group will be noted in the specification. Exemplary aryl groups include: phenyl; (C₁-C₄)alkylphenyl, such as tolyl and ethylphenyl; indenyl; naphthalenyl, tetrahydronaphthyl, tetrahydroindenyl; tetrahydroanthracenyl; and, anthracenyl. And a preference for phenyl groups may be noted.

As used herein, “C₂-C₂₀ alkenyl” refers to hydrocarbyl groups having from 2 to 20 carbon atoms and at least one unit of ethylenic unsaturation. The alkenyl group can be straight chained, branched or cyclic and may optionally be substituted with one or more halogen. Where applicable for a given moiety (R), a tolerance for one or more non-halogen substituents within an alkenyl group will be noted in the specification. The term “alkenyl” also encompasses radicals having “cis” and “trans” configurations, or alternatively, “E” and “Z” configurations, as appreciated by those of ordinary skill in the art. In general, however, a preference for unsubstituted alkenyl groups containing from 2 to 10 (C₂₋₁₀) or 2 to 8 (C₂₋₈) carbon atoms should be noted. Examples of said C₂-C₁₂ alkenyl groups include, but are not limited to: —CH═CH₂; —CH═CHCH₃; —CH₂CH═CH₂; —C(═CH₂)(CH₃); —CH═CHCH₂CH₃; —CH₂CH═CHCH₃; —CH₂CH₂CH═CH₂; —CH═C(CH₃)₂; —CH₂C(═CH₂)(CH₃); —C(═CH₂)CH₂CH₃; —C(CH₃)═CHCH₃; —C(CH₃)CH═CH₂; —CH═CHCH₂CH₂CH₃; —CH₂CH═CHCH₂CH₃; —CH₂CH₂CH═CHCH₃; —CH₂CH₂CH₂CH═CH₂; —C(═CH₂)CH₂CH₂CH₃; —C(CH₃)═CHCH₂CH₃; —CH(CH₃)CH═CHCH; —CH(CH₃)CH₂CH═CH₂; —CH₂CH═C(CH₃)₂; 1-cyclopent-1-enyl; 1-cyclopent-2-enyl; 1-cyclopent-3-enyl; 1-cyclohex-1-enyl; 1-cyclohex-2-enyl; and, 1-cyclohexyl-3-enyl.

As used herein, “alkylaryl” refers to alkyl-substituted aryl groups, both groups being defined as above. Further, as used herein “aralkyl” means an alkyl group substituted with an aryl radical as defined above.

The term “hetero” as used herein refers to groups or moieties containing one or more heteroatoms, such as N, O, Si and S. Thus, for example “heterocyclic” refers to cyclic groups having, for example, N, O, Si or S as part of the ring structure. “Heteroalkyl”, “heterocycloalkyl” and “heteroaryl” moieties are alkyl, cycloalkyl and aryl groups as defined hereinabove, respectively, containing N, O, Si or S as part of their structure.

The term “equivalent weight” as used herein refers to the molecular weight divided by the number of a function concerned. As such, “epoxy equivalent weight” (EEW) means the weight of resin, in grams, that contains one equivalent of epoxy.

As used herein, the term “epoxide” denotes a compound characterized by the presence of at least one cyclic ether group, namely one wherein an ether oxygen atom is attached to two adjacent carbon atoms thereby forming a cyclic structure. The term is intended to encompass monoepoxide compounds, polyepoxide compounds (having two or more epoxide groups) and epoxide terminated prepolymers. The term “monoepoxide compound” is meant to denote epoxide compounds having one epoxy group. The term “polyepoxide compound” is meant to denote epoxide compounds having at least two epoxy groups. The term “diepoxide compound” is meant to denote epoxide compounds having two epoxy groups.

The epoxide may be unsubstituted but may also be inertly substituted. Exemplary inert substituents include chlorine, bromine, fluorine and phenyl.

The molecular weights referred to in this specification can be measured with gel permeation chromatography (GPC) using polystyrene calibration standards, such as is done according to ASTM 3536.

As used herein, the term softening point (° C.) used in regard to waxes herein is the Ring & Ball softening point, which is measured unless otherwise indicated according to ASTM E28.

Viscosities of the compositions described herein are, unless otherwise stipulated, measured using the Anton Paar Viscometer, Model MCR 301 at standard conditions of 25° C. and 50% Relative Humidity (RH). The viscometer is calibrated one time a year and checked by services. The calibration is done with using special oils of known viscosity, which vary from 5,000 cps to 50,000 cps (parallel plate PP25 and at shear rate 1 s⁻¹ at 23° C.). Measurements of the compositions according to the present invention are done using the parallel plate PP25 at different shear rates from 1.5 to 100 s⁻¹.

### DETAILED DESCRIPTION OF THE INVENTION

### First Part of the Two-Part (2K) Composition

The first part of the two-part (2K) composition necessarily comprises: (meth)acrylate monomer; co-polymerizable acid; and, an electrolyte.

### (Meth)Acrylate Monomer

The first part of the composition comprises (meth)acrylate monomer which will typically be present in an amount of from 20 to 80 wt. %, based on the weight of said first part: it is preferred that (meth)acrylate monomer constitutes from 30 to 60 wt. %, for example from 35 to 50 wt. % of said first part.

These (meth)acrylate monomer quantities are preferred because a quantity greater than 80% may adversely affect initial adhesion properties and debonding effect, whereas low quantities, mainly below 20% may lead to decrease in initial adhesion properties.

There is no particular intention to limit (meth)acrylate esters having utility herein and it is considered that the (meth)acrylate monomers may be any ester of acrylic acid or methacrylic acid known to the art. That said, exemplary (meth)acrylic monomers include but are not limited to:
C₁-C₁₈ alkyl esters of (meth)acrylic acid, such as methyl (meth)acrylate, ethyl (meth)acrylate, n-propyl (meth)acrylate, isopropyl (meth)acrylate, butyl (meth)acrylate (all isomers), hexyl (meth)acrylate, n-heptyl(meth)acrylate, n-octyl(meth)acrylate, 2-ethylhexyl (meth)acrylate, n-nonyl(meth)acrylate, n-decyl(meth)acrylate, n-dodecyl(meth)acrylate and n-stearyl(meth)acrylate;
C₃-C₁₈ cycloalkyl esters of (meth)acrylic acid, such as cyclohexyl(meth)acrylate and isobornyl(meth)acrylate;
C₆-C₁₈ aryl esters of (meth)acrylic acid, such as phenyl(meth)acrylate and tolyl(meth)acrylate;
C₇-C₂₄ aralkyl esters of (meth)acrylic acid, such as benzyl(meth)acrylate;
C₁-C₁₈ alkoxyalkyl esters of (meth)acrylic acid, such as 2-methoxyethyl(meth)acrylate, 2-ethoxyethyl(meth)acrylate and 3-methoxybutyl(meth)acrylate;
fluorine-containing C₁-C₁₈ alkyl esters of (meth)acrylic acid, such as trifluoromethylmethyl(meth)acrylate, 2-trifluoromethylethyl(meth)acrylate, 2-perfluoroethylethyl(meth)acrylate, 2-perfluoroethyl-2-perfluorobutylethyl(meth)acrylate, 2-perfluoroethyl(meth)acrylate, perfluoromethyl(meth)acrylate, diperfluoromethylmethyl(meth)acrylate, 2-perfluoromethyl-2-perfluoroethylmethyl(meth)acrylate, 2-perfluorohexylethyl(meth)acrylate, 2-perfluorodecylethyl(meth)acrylate and 2-perfluorohexadecylethyl(meth)acrylate;
C₁-C₁₈ hydroxyalkyl esters of (meth)acrylic acid, such as 2-hydroxyethyl(meth)acrylate, 2-hydroxypropyl(meth)acrylate and pentaerythritol tri(meth)acrylate;
di/poly-esters of di/poly-functional alcohols, such as ethylene glycol di(meth)acrylate, 1,3 or 1,4-butanediol di(meth)acrylate, 1,6-hexanediol di(meth)acrylate and trimethylolpropane tri(meth)acrylate;
C₁-C₁₈ aminoalkyl esters of (meth)acrylic acid, such as 2-aminoethyl(meth)acrylate, dimethylaminoethyl (meth)acrylate and (meth)acryloxyethoxyethylamine;
C₁-C₁₈ alkoxysilyl-containing alkyl esters of (meth)acrylic acid, such as γ-(methacryloyloxypropyl)trimethoxysilane;
ethylene oxide or propylene oxide adducts of (meth)acrylic acid; and,
(meth)acrylate esters formed by alcohols bearing other functional groups, such as tetrahydrofurfuryl (meth)acrylate.

For completeness, it is not precluded that the first part of the composition comprises a macro-monomer component consisting of one or more oligomers selected from the group consisting of urethane (meth)acrylates, polyester (meth)acrylates and polyether (meth)acrylates. However, such oligomeric compounds—which may be mono- or polyfunctional with respect to the polymerizable (meth)acrylate functionality but which are based on repeated structural urethane, ester and ether subunits—should not usually constitute more than 30 wt. % of the total of (meth)acrylate monomers in said first part.

As is known in the art, urethane (meth) acrylate oligomers may be prepared by reaction of a polyfunctional (meth)acrylate bearing a hydroxyl group with a polyisocyanate as defined herein above. In particular, the polyfunctional (meth)acrylate bearing a hydroxyl group may be selected from the group consisting of: 2-hydroxyethyl (meth)acrylate; 2-hydroxyisopropyl (meth)acrylate; 4-hydroxybutyl (meth)acrylate; hydroxyethylcaprolactone (meth)acrylate; pentaerythritol tri(meth)acrylate; pentaerythritol tetra(meth)acrylate; dipentaerythritol penta(meth)acrylate; dipentaerythritol hexa(meth)acrylate; and, combinations thereof.

Suitable polyester (meth)acrylate oligomers are obtained by reacting (meth)acrylic acid with a polyester prepared from a polybasic acid or an anhydride thereof and a polyhydric alcohol. Examples of the polybasic acid include but are not limited to: phthalic acid; succinic acid; adipic acid; glutaric acid; sebacic acid; isosebacic acid; tetrahydrophthalic acid; hexahydrophthalic acid; dimer acid; trimellitic acid; pyromellitic acid; pimelic acid; and, azelaic acid. Examples of the polyhydric alcohol include but are not limited to: 1,6-hexanediol; diethylene glycol; 1,2-propylene glycol; 1,3-butylene glycol; neopentyl glycol; dipropylene glycol; polyethylene glycol; and, polypropylene glycol.

As is known in the art, polyether (meth)acrylate oligomers may be obtained by an ester exchange reaction between a polyether and a (meth)acrylate ester, such as ethyl methacrylate. Exemplary polyethers include polyethers obtained from ethoxylated or propoxylated trimethylolpropane, pentaerythritol or the like, or by polyetherification of 1,4-propanediol or the like.

In preferred embodiment, the first part comprises at least one (meth)acrylate monomer selected from the group consisting of: methyl (meth)acrylate; ethyl (meth)acrylate; n-propyl (meth)acrylate; isopropyl (meth)acrylate; n-butyl(meth)acrylate; isobutyl (meth)acrylate; tert-butyl (meth)acrylate; n-pentyl (meth)acrylate; n-hexyl (meth)acrylate; cyclohexyl (meth)acrylate; n-heptyl (meth)acrylate; n-octyl(meth)acrylate; 2-ethylhexyl-(meth)acrylate; nonyl (meth) acrylate; decyl (meth)acrylate; dodecyl (meth)acrylate; phenyl (meth)acrylate; tolyl (meth)acrylate; benzyl (meth)acrylate; 2-methoxyethyl (meth)acrylate; 3-methoxybutyl (meth)acrylate; 2-hydroxyethyl (meth)acrylate; 2-hydroxypropyl(meth)acrylate; stearyl(meth)acrylate; glycidyl (meth)acrylate; isobornyl (meth)acrylate; 2-aminoethyl (meth)acrylate; y-(meth)acryloyloxypropyl trimethoxysilane; (meth)acrylic acid-ethylene oxide adduct; trifluoromethylmethyl (meth)acrylate; 2-trifluoromethylethyl (meth)acrylate; 2-perfluoro ethylethyl (meth)acrylate; 2-perfluoroethyl-2-perfluorobutylethyl (meth)acrylate; 2-perfluoroethyl (meth)acrylate; perfluoromethyl (meth)acrylate; diperfluoromethylmethyl (meth)acrylate; 2-perfluoromethyl-2-perfluoroethylmethyl (meth)acrylate; 2-perfluorohexylethyl (meth)acrylate; 2-perfluorodecylethyl (meth)acrylate; 2-perfluorohexadecylethyl (meth)acrylate; ethoxylated trimethylolpropane triacrylate; trimethylol propane trimethacrylate; dipentaerythritol monohydroxypentacrylate; pentaerythritol triacrylate; ethoxylated trimethylolpropane triacrylate; 1,6-hexanedioldiacrylate; neopentyl glycoldiacrylate; pentaerythritol tetraacrylate; 1,2-butylene glycoldiacrylate; trimethylopropane ethoxylate tri(meth)acrylate; glyceryl propoxylate tri(meth) acrylate; trimethylolpropane tri(meth)acrylate; dipentaerythritol monohydroxy penta(meth)acrylate; tripropyleneglycol di(meth)acrylate; neopentylglycol propoxylate di(meth)acrylate; 1,4-butanediol di(meth)acrylate; triethyleneglycol di(meth)acrylate; butylene glycol di(meth)acrylate; and, ethoxylated bisphenol A di(meth)acrylate.

Good results have been obtained where the first part comprises at least one (meth)acrylate monomer selected from the group consisting of methyl (meth)acrylate, ethyl (meth)acrylate, isobornyl (meth)acrylate, ethoxylated trimethylolpropanetriacrylate and trimethylolpropane triacrylate. The use of methyl methacrylate in the first part is particularly preferred.

The above listed (meth)acrylate monomers are preferred because it is believed that the size of the monomer leads to a formation of an ideal polymer network, which increases ion transport.

It is known in the art that incorporation of certain additional, non-polymerizing functionalities into (meth)acrylate monomers can improve the surface adhesion of polymers derived therefrom. Mention in this regard may be made of anhydride, phosphate or phosphonate functionalities and (meth)acrylate monomers bearing such functionalities may be used in the first part of the present composition. A listing of such phosphorus compounds is found in U.S. Pat. No. 4,223,115. Exemplary monomers include: 2-monomethacryloxyethyl phosphate; bis(2-methacryloxyethyl) phosphate; 2-acryloyloxyethyl phosphate; bis-(2-acryloyloxyethyl) phosphate; methyl-(2-methacryloyloxyethyl) phosphate; ethyl methacryloyloxyethyl phosphate; methyl acryloyloxyethyl phosphate; ethyl acryloyloxyethyl phosphate; 2-hydroxyethyimethacrylate phosphate; 10-[(2-methyl prop-2eonyl)oxy]decyl dihydrogen phosphate (10-rmethacryloyloxydecyl dihydrogen phosphate); and, 4-methacryloxyethyl trimellitic anhydride.

### Co-Polymerizable Acid

As noted above, the first part of the composition comprises co-polymerizable acid which should typically be employed in an amount of from 0.5 to 20 wt. %, based on the weight of the first part: the co-polymerizable acid may preferably constitute from 5 to 15 wt. %, for example from 6 to 12 wt. % of said first part. For completeness, whilst such monomers should typically be used in the form of free acid, it is not precluded that the constituent acid groups of the monomers be partially or completely neutralized with suitable bases, provided this does not compromise their participation in co-polymerization.

It is considered that the co-polymerizable acid will improve the cure speed and metal adhesion of the composition. The aforementioned quantities of co-polymerizable acid are preferred because a quantity greater than 20 wt. %, based on the weight of the first part, may cause corrosion issues and gas evolution, whereas quantities below 0.5 wt. %, based on the weight of the first part, may lead to an incomplete cure and therefore decrease initial adhesion properties.

Without intention to limit the present invention, co-polymerizable acid monomers should be selected from: ethylenically unsaturated carboxylic acids; ethylenically unsaturated sulfonic acids; and; vinylphosphonic acid. Suitable ethylenically unsaturated sulfonic acids are, for instance, vinylsulfonic acid, styrenesulfonic acid and acrylamidomethylpropanesulfonic acid.

Preferably the co-polymerizable acid of this part comprises or consists of ethylenically unsaturated carboxylic acids selected from the group consisting of: α,β-monoethylenically unsaturated monocarboxylic acids; α,β-monoethylenically unsaturated dicarboxylic acids; C₁-C₆ alkyl half-esters of α,β-monoethylenically unsaturated dicarboxylic acids; α,β-monoethylenically unsaturated tricarboxylic acids; and, C₁-C₆ alkyl esters of α,β-monoethylenically unsaturated tricarboxylic acids bearing at least one free carboxylic acid group; and, mixtures thereof. In particular, the co-polymerizable acid of this part comprises or consists of at least one acid selected from methacrylic acid, acrylic acid, itaconic acid, maleic acid, aconitic acid, crotonic acid and fumaric acid.

It is noted that the present invention does not preclude the presence in the first part of vinyl monomers which can be copolymerized with (meth)acrylate monomers and which are selected from the group consisting of: styrene monomers, such as styrene, vinyltoluene, α-methylstyrene and chlorostyrene; fluorine containing vinyl monomers, such as perfluoroethylene, perfluoropropylene and fluorinated vinylidene; silicon containing vinyl monomers such as vinyltrimethoxysilane and vinyltriethoxysilane; maleimide monomers, such as maleimide, methylmaleimide, ethylmaleimide, propylmaleimide, butylmaleimide, hexylmaleimide, octylmaleimide, dodecylmaleimide, stearylmaleimide, phenylmaleimide and cyclohexylmaleimide; nitrile group containing vinyl monomers, such as acrylonitrile and methacrylonitrile; amide group containing vinyl monomers, such as acrylamide and methacrylamide; vinyl esters such as vinyl acetate, vinyl propionate, vinyl pivalate, vinyl benzoate and vinyl cinnamate; alkenes such as ethylene and propylene; conjugated dienes such as butadiene and isoprene; and vinyl chloride, vinylidene chloride, allyl chloride and allylalcohol. However, when included, such vinyl co-monomers should constitute less than 40 wt. %, preferably less than 20 wt. % or less than 10 wt. %, based on the total weight of co-polymerizable acid monomers.

### Electrolyte

The first part of the composition comprises from 0.5 to 20 wt. %, based on the weight of the first part, of electrolyte: the electrolyte may preferably constitute from 5 to 15 wt. %, for example from 6 to 12 wt. %, of said first part. These quantities are preferred because a quantity greater than 20 wt. % of electrolyte, based on the weight of said first part, may result in a good debonding effect but cure may be incomplete and, therefore, initial adhesive properties may be adversely affected. Conversely, at amounts less than 0.5 wt. %, based on the weight of said first part, the debonding effect may be compromised.

The electrolyte comprises or consists of at least one salt in accordance with Formula (1) or Formula (11):

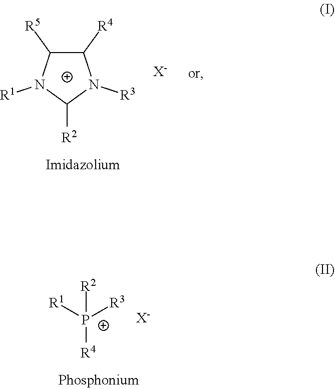

wherein: R¹, R², R³, R⁴ and R⁵ are independently selected from hydrogen, C₁-C₁₈ alkyl, C₃-C₁₈ cycloalkyl, C₆-C₁₈ aryl, C₇-C₂₄ aralkyl, C₂-C₂₀ alkenyl, —C(O)R^{q}, —C(O)OH, —CN or —NO₂; and, R^{q} is C₁-C₆ alkyl; and, X⁻ is a counter anion selected from the group consisting of:

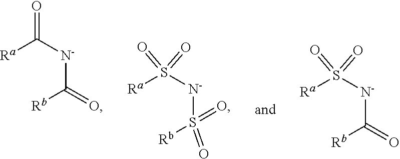

in which general formulae R^{a} and R^{b} are independently selected from hydrogen, C₁-C₁₂ alkyl, C₅-C₁₂ cycloalkyl, C₅-C₁₂ heterocycloalkyl, C₆-C₁₈ aryl or C₅-C₁₈ heteroaryl.

For completeness, in Formula (I) and Formula (II) the terms C₁-Cₙ alkyl, C₃-Cₙ cycloalkyl, C₆-C₁₈ aryl, C₇-C₂₄ aralkyl, C₂-C₂₀ alkenyl expressly include groups wherein one or more hydrogen atoms are substituted by halogen atoms (e.g. C₁-C₁₈ haloalkyl) or hydroxyl groups (e.g. C₁-C₁₈ hydroxyalkyl). In particular, it is preferred that R¹, R², R³, R⁴ and R⁵ are independently selected from hydrogen, C₁-C₁₈ alkyl, C₁-C₁₈ haloalkyl, C₁-C₁₈ hydroxyalkyl or C₃-C₁₈ cycloalkyl. For example, R¹, R², R³, R⁴ and R⁵ may be independently selected from hydrogen, C₁-C₁₈ alkyl or C₁-C₁₈ haloalkyl.

As regards said carboxylic acid imide, bis(sulfonyl)imide or sulfonylimide counter anion (X⁻) of Formula (I) or Formula (II), it is preferred that R^{a} and R^{b} are independently selected from hydrogen, C₁-C₁₂ alkyl or C₁-C₁₂ haloalkyl. For example, R^{a} and R^{b} may be independently selected from hydrogen, C₁-C₈ alkyl or C₁-C₈ haloalkyl or R^{a} and R^{b} may be independently selected from hydrogen, C₁-C₄ alkyl or C₁-C₄ haloalkyl. A particularly preferred counter anion (X⁻) is bis(trifluoromethylsulfonyl) imide.

The electrolyte of the first part is preferably selected from the group consisting of: 1-methylimidazolium bis(trifluoromethylsulfonyl)imide; 3-methylimidazolium bis(trifluoromethylsulfonyl) imide; 1-ethyl-3-methylimidazolium bis(trifluoromethylsulfonyl)imide; 1-propyl-3-methylimidazolium bis(trifluoromethylsulfonyl)imide; 1-butyl-3-methylimidazolium bis(trifluoromethylsulfonyl)imide; 1-butyl-2,3-dimethylimidazolium bis(trifluoromethylsulfonyl) imide; 1-hexyl-3-methylimidazolium bis(trifluoromethylsulfonyl)imide; 1-octyl-3-methylimidazolium bis(trifluoromethylsulfonyl)imide; 1-methyl-3-octylimidazolium bis(trifluoromethylsulfonyl)imide; 1-decyl-3-methylimidazolium bis(trifluoromethylsulfonyl)imide; 1-dodecyl-3-methylimidazolium bis(trifluoromethylsulfonyl)imide; tetraethylphosphonium bis(trifluoromethylsulfonyl)imide; tetrabutylphosphonium bis(trifluoromethylsulfonyl)imide; tridecyl(tetradecyl)phosphonium bis(trifluoromethylsulfonyl)imide; trihexyltetradecylphosphonium bis(trifluoromethylsulfonyl)amide and, mixtures thereof. A particular preference for the use of at least one of 1-butyl-3-methylimidazolium bis(trifluoromethylsulfonyl)imide, 1-dodecyl-3-methylimidazolium bis(trifluoromethylsulfonyl)imide and trihexyltetradecylphosphonium bis(trifluoromethylsulfonyl)amide may be mentioned.

The presence in the electrolyte of compatible electrolytic compounds not conforming to Formula (I) or Formula (II) is not precluded. However, said compound(s) of Formula (I) or Formula (II) should constitute at least 90 wt. %, preferably at least 95%, more preferably at least 99 wt. % and most preferably 100 wt. % of the electrolyte.

### Second Part of the Two-Part (2K) Composition

The second part of the two-part composition comprises: a first curing agent for the monomers of the first part; a second curing agent for the monomers of the first part; a wax, and, a solubilizer.

### First Curing Agent

As noted above, the second part of the composition comprises a first curing agent which should typically be employed in an amount of from 5 to 40 wt. %, based on the weight of said second part: the first curing agent may preferably constitute from 10 to 40 wt. %, for example from 20 to 40 wt. % of said second part.

These first curing agent quantities are preferred because a quantity greater than 40 wt. %, based on the weight of said second part, may lead to excess of a first curing agent and unwanted reactions may adversary affect the properties of the composition; conversely, low quantities, mainly below 5 wt. % may lead to an incomplete cure and therefore poor initial adhesion properties.

In an important embodiment, the first curing agent comprises or consists of at least one free radical initiator which decomposes under the action of heat to provide free radicals. Exemplary heat-activated free-radical initiators include: peroxides, including ketone peroxides; hydroperoxides; peroxycarbonates; peracetic acids; azo compounds, such as 2,2′-azobisisobutyronitrile (AIBN) or 2,2′-azobis(2,4-dimethylpentanenitrile), 4,4′-azobis(4-cyanovaleric acid), or 1,1′-azobis (cyclohexanecarbonitrile); tetrazines; and, persulfate compounds, such as potassium persulfate. Free radical initiators that are solids at room temperature are preferred. Independently of or additional to that statement of preference, it is desirable that said free radical initiators have a half-life of at least 10 hours at a temperature of 60° C.

While certain peroxides—such as dialkyl and diaryl peroxides—have been disclosed as useful curing agents in inter alia U.S. Pat. No. 3,419,512 (Lees) and U.S. Pat. No. 3,479,246 (Stapleton) and indeed have utility herein, hydroperoxides also represent an important class of curing agent for the present invention. In this context, whilst hydrogen peroxide itself may be used, it is preferred to employ organic hydroperoxides. For completeness, included within the definition of hydroperoxides are materials such as organic peroxides or organic peresters which decompose or hydrolyze to form organic hydroperoxides in situ: examples of such peroxides and peresters are cyclohexyl and hydroxycyclohexyl peroxide and t-butyl perbenzoate, respectively.

Without intention to limit the present invention, representative hydroperoxide compounds have the general formula:

R^{p}OOH
wherein: R^{p} is a hydrocarbon group containing up to 18 carbon atoms, and
preferably wherein: R^{p} is a C₁-C₁₂ alkyl, C₆-C₁₈ aryl or C₇-C₁₈ aralkyl group.

As exemplary compounds, which may be used alone or in combination as the first curing agent, there may be mentioned: cumene hydroperoxide (CHP); para-menthane hydroperoxide; t-butyl hydroperoxide (TBH); t-butyl perbenzoate; t-butyl peracetate; t-amyl hydroperoxide; 1,2,3,4-tetramethylbutyl hydroperoxide; lauryl peroxide; benzoyl peroxide (also (known as dibenzoyl peroxide, C₁₄H₁₀O₄, CAS No. 94-36-0); 1,3-bis(t-butylperoxyisopropyl) benzene; diacetyl peroxide; butyl-4,4-bis(t-butylperoxy)valerate; p-chlorobenzoyl peroxide; t-butyl cumyl peroxide; di-t-butyl peroxide; dicumyl peroxide; 2,5-dimethyl-2,5-di-t-butylperoxyhexane; 2,5-dimethyl-2,5-di-t-butyl-peroxyhex-3-yne; and, 4-methyl-2,2-di-t-butylperoxypentane.

Preferably said first curing agent is a peroxide or hydroperoxide compound selected from the group consisting of tert-butyl peroxide, tert-butyl perbenzoate, cumene hydroperoxide, tert-butyl peroxybenzoate, diacetyl peroxide, benzoyl peroxide, tert-butyl peracetate, lauryl peroxide and mixtures thereof: a particular preference for benzoyl peroxide is noted.

Where the first curing agent is an oxidizing agent—such as the aforementioned peroxide and hydroperoxide compounds—the composition may further comprise an activator. When combined in an appropriate proportion, the oxidizing agent and the activator (reducing agent) yield polymerization initiating radicals, even under mild conditions without a supplementary energy source. Either the oxidizing agent alone or both of the oxidizing agent and the reducing agent may provide polymerization initiating radicals.

Exemplary activators or reducing agents may be selected from the group consisting of: alkali metal sulfites; alkali metal hydrogensulfites; alkali metal metabisulfites; formaldehyde sulfoxylates; alkali metal salts of aliphatic sulfinic acids; alkali metal hydrogensulfides; salts of polyvalent metals, in particular Co(II) salts and Fe(II) salts such iron(II) sulfate, iron(II) ammonium sulfate or iron(II) phosphate; dihydroxymaleic acid; benzoin; ascorbic acid; reducing amines, in particular aromatic tertiary amines such as N,N-bis(2-hydroxyethyl)-p-toluidine (diethanol-para-toluidine, DE-p-T), 2-(4-dimethylaminophenyl)ethyl alcohol (DMAPE), 4-tert butyl dimethyl aniline, 3-dimethylaminobenzoic acid, 4-dimethylaminobenzoic acid, ethyl 4-dimethylaminobenzoate (EDMAB), 2-ethylhexyl 4-dimethylaminobenzoate and 4-dimethylaminobenzoate; and, reducing saccharides, such as sorbose, glucose, fructose and/or dihydroxyacetone.

It would be conventional for the activator (reducing agent) to be included in the first component with the polymerizable species. It is however not precluded that the activator be added to the second component shortly prior to the contacting of the first and second components.

### Second Curing Agent

As noted above, the second part of the composition comprises a second curing agent which should typically be employed in an amount of from 0.01 to 2 wt. %, based on the weight of said second part: the second curing agent may preferably constitute from 0.01 to 1 wt. %, for example from 0.01 to 0.5 wt. % of said second part.

In an important embodiment, the second curing agent comprises or consists of at least one compound which is a salt or a complex of a transition metal, which transition metal may be selected from the group consisting of Fe, Co, V, Ti, Mn, Cu, Sn, Cr, Ni, Mo, Ge, Sr, Pd, Pt, Nb, Sb, Re, Os, Ir, Pt, Au, Hg, Te, Rb and Bi and should, in particular, be selected from the group consisting of Fe, Co, V, Mn and Cu. It is noted that both Fe(II) and Fe(III) complexes can be used.

It has proved advantageous for the second agent to comprise or consist of at least one iron compound selected from the group consisting of: iron carboxylates; iron 1,3-dioxo complexes; ammonium-ferric-ferrocyanide; and, iron dicylcopentadienyl complexes. In this regard, exemplary iron carboxylates include iron lactate, iron naphthenate, iron 2-ethyl hexanoate (iron octanoate), iron formate, iron acetate, iron propionate, iron butyrate, iron pentanoate, iron hexanoate, iron heptanoate, iron nonanoate, iron decanoate, iron neodecanoate and iron dodecanoate. Exemplary iron 1,3-dioxo complexes include iron acetoacetonate, and the iron complexes of acetyl acetone, benzoyl acetone, dibenzoyl methane and acetoacetates such as diethyl acetoacetamide, dimethyl acetoacetamide, dipropylacetoacetamide, dibutylacetoacetamide, methyl acetoacetate, ethyl acetoacetate, propyl acetoacetate and butylacetoacetate. Examples of iron dicylcopentadienyl complexes are those complexes comprising iron and two substituted or unsubstituted cyclopentadienyl ligands, wherein the optional substituents on the cyclopentadienyl ring are selected from the group consisting of C₁-C₁₂ alkyl, C₆-C₁₈ aryl, and C₇-C₁₈ aralkyl groups. A particular example of an iron dicylcopentadienyl complex is ferrocene (bis(η5-cyclopentadienyl)iron).

As further exemplary transition metal compounds which may be used in or as the second curing agent, particular mention may be made of salts and complexes of copper, cobalt, vanadium and manganese. Herein cobalt compounds can be used as the transition metal without legislative and toxicity issues on account of the small amounts utilized. Suitable counteranions present in the salts include: halide; nitrate; sulphate; sulphonate; phosphate; phosphonate; oxide; or, carboxylate, such as lactate, 2-ethyl hexanoate, acetate, proprionate, butyrate, oxalate, laurate, oleate, linoleate, palmitate, stearate, acetyl acetonate, octanoate, nonanoate, heptanoate, neodecanoate or naphthenate.

### Waxes

Whilst the presence of waxes in the first component is not precluded, the present composition is characterized in the second part comprises from 5 to 30 wt. %, based on the weight of said part, of at least one wax. Said wax(es) may, for example, constitute from 5 to 20 wt. % or from 5 to 15 wt. % of said second part. Upon mixing the first and second parts of the composition, said at least one wax serves to limit the evaporation of the monomers present, in particular of (meth)acrylate monomers.

Without intention to limit the present invention, waxes having utility in the present invention should have a softening point of from 50 to 150° C. and may include one or more of: polyethylene having a number average molecular weight (Mn) from 500 to 7500; petroleum waxes, such as paraffin wax and microcrystalline wax; synthetic waxes made by polymerizing carbon monoxide and hydrogen, such as Fischer-Tropsch wax; polyolefin waxes including functionalized polyolefin waxes of which maleated polyethylene, maleated polypropylene and maleated poly(ethylene-co-propylene) may be mentioned as examples; and, hydrogenated animal, fish or vegetable oils.

### Solubilizer

The second part of the two-part (2K) composition necessarily comprises a solubilizer which is conventionally present in an amount of from 20 to 60 wt. %, based on the weight of the second part: preferably the solubilizer constitutes from 30 to 60 wt. %, for example from 40 to 60 wt. % of said second part. At solubilizer quantities greater than 60 wt. %, based on the weight of said second part, the adhesion and cure properties of the composition may be adversely affected.

The solubilizer has the function of promoting the miscibility of the electrolyte within the adhesive composition formed upon admixture of the two parts thereof: the solubilizer may or may not form part of the polymer matrix formed upon curing of the adhesive composition but does serve to facilitate ion transfer therein. The solubilizer is, as such, preferably a polar compound and should desirably be liquid at room temperature.

In a first embodiment, the solubilizer comprises or consists of one or more liquid epoxy resins. Epoxy resins as used herein may include mono-functional epoxy resins, multi- or poly-functional epoxy resins, and combinations thereof. The epoxy resins may be pure compounds but equally may be mixtures of epoxy functional compounds, including mixtures of compounds having different numbers of epoxy groups per molecule. An epoxy resin may be saturated or unsaturated, aliphatic, cycloaliphatic, aromatic or heterocyclic and may be substituted. Further, the epoxy resin may be monomeric or polymeric.

Without intention to limit the present invention, illustrative monoepoxide compounds include: alkylene oxides; epoxy-substituted cycloaliphatic hydrocarbons, such as cyclohexene oxide, vinylcyclohexene monoxide, (+)-cis-limonene oxide, (+)-cis,trans-limonene oxide, (−)-cis,trans-limonene oxide, cyclooctene oxide, cyclododecene oxide and α-pinene oxide; epoxy-substituted aromatic hydrocarbons; monoepoxy substituted alkyl ethers of monohydric alcohols or phenols, such as the glycidyl ethers of aliphatic, cycloaliphatic and aromatic alcohols; monoepoxy-substituted alkyl esters of monocarboxylic acids, such as glycidyl esters of aliphatic, cycloaliphatic and aromatic monocarboxylic acids; monoepoxy-substituted alkyl esters of polycarboxylic acids wherein the other carboxy group(s) are esterified with alkanols; alkyl and alkenyl esters of epoxy-substituted monocarboxylic acids; epoxyalkyl ethers of polyhydric alcohols wherein the other OH group(s) are esterified or etherified with carboxylic acids or alcohols; and, monoesters of polyhydric alcohols and epoxy monocarboxylic acids, wherein the other OH group(s) are esterified or etherified with carboxylic acids or alcohols.

By way of example, the following glycidyl ethers might be mentioned as being suitable monoepoxide compounds for use herein: methyl glycidyl ether; ethyl glycidyl ether; propyl glycidyl ether; butyl glycidyl ether; pentyl glycidyl ether; hexyl glycidyl ether; cyclohexyl glycidyl ether; octyl glycidyl ether; 2-ethylhexyl glycidyl ether; allyl glycidyl ether; benzyl glycidyl ether; phenyl glycidyl ether; 4-tert-butylphenyl glycidyl ether; 1-naphthyl glycidyl ether; 2-naphthyl glycidyl ether; 2-chlorophenyl glycidyl ether; 4-chlorophenyl glycidyl ether; 4-bromophenyl glycidyl ether; 2,4,6-trichlorophenyl glycidyl ether; 2,4,6-tribromophenyl glycidyl ether; pentafluorophenyl glycidyl ether; o-cresyl glycidyl ether; m-cresyl glycidyl ether; and, p-cresyl glycidyl ether.

In certain embodiments, the monoepoxide compound conforms to Formula (III) herein below:

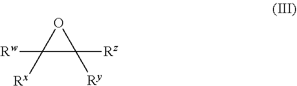

wherein: R^{w}, R^{x}, R^{y} and R^{z} may be the same or different and are independently selected from hydrogen, a halogen atom, a C₁-C₈ alkyl group, a C₃ to C₁₀ cycloalkyl group, a C₂-C₁₂ alkenyl, a C₆-C₁₈ aryl group or a C₇-C₁₈ aralkyl group, with the proviso that at least one of R^{y} and R^{z} is not hydrogen.

It is preferred that R^{w}, R^{x} and R^{y} are hydrogen and R^{z} is either a phenyl group or a C₁-C₈ alkyl group and, more preferably, a C₁-C₄ alkyl group.

Having regard to these embodiments, exemplary monoepoxides include: ethylene oxide; 1,2-propylene oxide (propylene oxide); 1,2-butylene oxide; cis-2,3-epoxybutane; trans-2,3-epoxybutane; 1,2-epoxypentane; 1,2-epoxyhexane; 1,2-heptylene oxide; decene oxide; butadiene oxide; isoprene oxide; and, styrene oxide.

In the present invention, reference is made to using at least one monoepoxide compound selected from the group consisting of: ethylene oxide; propylene oxide; cyclohexene oxide; (+)-cis-limonene oxide; (+)-cis,trans-limonene oxide; (−)-cis,trans-limonene oxide; cyclooctene oxide; and, cyclododecene oxide.

Again, without intention to limit the present invention, suitable polyepoxide compounds may be liquid, solid or in solution in solvent. Further, such polyepoxide compounds should have an epoxide equivalent weight of from 100 to 700 g/eq, for example from 120 to 320 g/eq. And generally, diepoxide compounds having epoxide equivalent weights of less than 500 g/eq. or even less than 400 g/eq. are preferred: this is predominantly from a costs standpoint, as in their production, lower molecular weight epoxy resins require more limited processing in purification.

As examples of types or groups of polyepoxide compounds which may be polymerized in present invention, mention may be made of: glycidyl ethers of polyhydric alcohols and polyhydric phenols; glycidyl esters of polycarboxylic acids; and, epoxidized polyethylenically unsaturated hydrocarbons, esters, ethers and amides.

Suitable diglycidyl ether compounds may be aromatic, aliphatic or cycloaliphatic in nature and, as such, can be derivable from dihydric phenols and dihydric alcohols. And useful classes of such diglycidyl ethers are: diglycidyl ethers of aliphatic and cycloaliphatic diols, such as 1,2-ethanediol, 1,4-butanediol, 1,6-hexanediol, 1,8-octanediol, 1,12-dodecanediol, cyclopentane diol and cyclohexane diol; bisphenol A based diglycidylethers; bisphenol F diglycidyl ethers; polyalkyleneglycol based diglycidyl ethers, in particular polypropyleneglycol diglycidyl ethers; and, polycarbonatediol based glycidyl ethers.

Further illustrative polyepoxide compounds include but are not limited to: glycerol polyglycidyl ether; trimethylolpropane polyglycidyl ether; pentaerythritol polyglycidyl ether; diglycerol polyglycidyl ether; polyglycerol polyglycidyl ether; and, sorbitol polyglycidyl ether.

Glycidyl esters of polycarboxylic acids having utility in the present invention are derived from polycarboxylic acids which contain at least two carboxylic acid groups and no other groups reactive with epoxide groups. The polycarboxylic acids can be aliphatic, cycloaliphatic, aromatic and heterocyclic. The preferred polycarboxylic acids are those which contain not more than 18 carbon atoms per carboxylic acid group of which suitable examples include but are not limited to: oxalic acid; sebacic acid; adipic acid; succinic acid; pimelic acid; suberic acid; glutaric acid; dimer and trimer acids of unsaturated fatty acids, such as dimer and trimer acids of linseed fatty acids; phthalic acid; isophthalic acid; terephthalic acid; trimellitic acid; trimesic acid; phenylene-diacetic acid; chlorendic acid; hexahydrophthalic acid, in particular hexahydroorthophthalic acid (1,2-cyclohexanedicarboxylic acid); diphenic acid; naphthalic acid; polyacid terminated esters of di-basic acids and aliphatic polyols; polymers and co-polymers of (meth)acrylic acid; and, crotonic acid.

Other suitable diepoxides which might also be mentioned include: diepoxides of double unsaturated fatty acid C₁-C₁₈ alkyl esters; butadiene diepoxide; polybutadiene diglycidyl ether; vinylcyclohexene diepoxide; and, limonene diepoxide.

And examples of preferred polyepoxide compounds include: bisphenol-A epoxy resins, such as DER™ 331, DER™ 332, DER™ 383, JER™ 828 and Epotec YD 128; bisphenol-F epoxy resins, such as DER™ 354; bisphenol-A/F epoxy resin blends, such as DER™ 353; aliphatic glycidyl ethers, such as DER™ 736; polypropylene glycol diglycidyl ethers, such as DER™ 732; epoxy novolac resins, such as DEN™ 438; brominated epoxy resins such as DER™ 542; castor oil triglycidyl ether, such as ERISYS™ GE-35H; polyglycerol-3-polyglycidyl ether, such as ERISYS™ GE-38; sorbitol glycidyl ether, such as ERISYS™ GE-60; and, bis(2,3-epoxypropyl)cyclohexane-1,2-dicarboxylate, available as Lapox Arch-11. A particular preference for solubilizer comprising or consisting of bisphenol-A epoxy resin is noted.

Where the solubilizer of the second part of the composition is based on one or more epoxy resins, the present invention does not preclude the solubilizer from further comprising one or more cyclic compounds selected from the group consisting of: oxetanes; cyclic carbonates; cyclic anhydrides; and, lactones. The disclosures of the following citations may be instructive in disclosing suitable cyclic carbonate functional compounds: U.S. Pat. Nos. 3,535,342; 4,835,289; 4,892,954; UK Patent No. GB-A-1,485,925; and, EP-A-0 119 840. However, such further cyclic compounds should constitute less than 20 wt. %, preferably less than 10 wt. % or less than 5 wt. %, based on the total weight of the epoxide compounds.

In another embodiment, which is not intended to be mutually exclusive of that given above, the solubilizer of the second part comprises at least one polymer which is liquid at room temperature and which is selected from the group consisting of: polyphosphazenes; polymethylenesulfides; polyoxyalkylene glycols; and, polyethylene imines. A preference for polyoxy(C₂-C₃)alkylene glycols having a weight average molecular weight of from 350 to 10000 g/mol, for example 500 to 5000 g/mol, may be noted.

### Toughener

The composition of the present invention comprises a toughener which may be present in either or both of the first (A) and second (B) parts thereof. It is, however, preferred that the first component (A) comprises a toughener. That aside, the presence of tougheners in the composition is advantageous to the debonding of the cured adhesive. Without intention to be bound by theory, the toughener facilitates phase separation within the cured adhesive under the application of electrical potential.

It is preferred that said toughener should in toto be included in the composition in an amount of from 5 to 40 wt. %, for example in an amount of from 10 to 40 wt. % or from 20 to 40 wt. %, based on the total weight of the composition. These toughener quantities are preferred because a quantity greater than 40 wt. % may lead to inadequate adhesion properties, whereas quantities below 5 wt. % may lead to an inadequate debonding effect and a composition which is too flexible.

Good results have been obtained where the composition of the present invention contains at least one toughener selected from the group consisting of: non-reactive elastomers; and, core-shell rubber particles. The presence of non-reactive elastomers in the composition is preferred. A particular preference may be noted for the inclusion in the first part of the composition of a toughener comprising or consisting of at least one non-reactive elastomer.

The term “non-reactive”, as applied to the elastomeric component of the present composition, means that the polymer contains no activated double bond capable of free radical polymerization. The term “elastomeric” is defined as having the ability of a polymer, when provided as a strip, to return to its approximate initial length after elongation to below its breaking or fracture point.

Exemplary non-reactive elastomers having utility in the present invention include but are not limited to: i) elastomeric homopolymers of dienes, such as homopolymers of 1,3-butadiene, 2-methyl-1,3-butadiene (isoprene), 2-chloro-1,3-butadiene (chloroprene), 2,3-dimethyl-1,3-butadiene, 1,4-dimethyl-1,3-butadiene, 1,3-piperylene, 1,3-hexadiene, 2-methyl-1,3-pentadiene, 2-methyl-3-butyl-1,3-butadiene and 2,3-diethy-1,3-butadiene; ii) elastomeric copolymers of dienes with at least one modifying ethylenically unsaturated co-monomer such as ethylene, propylene, iso-butylene, styrene, α-(C₁-C₄-alkyl)styrene, (meth)acrylonitrile and methyl methacrylate, wherein said co-monomer(s) may typically constitute from 5 to 40 wt. % of said copolymer; iii) (meth)acrylic elastomeric polymers, such as all acrylic-based thermoplastic elastomers (TPEs); iv) natural rubber; and, v) polyethylene, polypropylene and ethylene-propylene copolymers.

As illustrative non-reactive elastomers there may be mentioned: ethylene/propylene/diene terpolymers; (meth)acrylonitrile-butadiene copolymers; (meth)acrylonitrile-styrene copolymers; (meth)acrylonitrile-butadiene-styrene copolymers; styrene-isoprene-styrene copolymers; styrene-butadiene-styrene copolymers; and, A-B-A triblock copolymers of which blocks A and B are composed respectively of C₁-C₈ alkyl (meth)acrylates with different glass transition temperatures (Tg), such as PMMA-PnBA-PMMA and PMMA-P(nBA/2-EHA)-PMMA triblock copolymers based on methyl (meth)acrylate (MMA), n-butyl acrylate (nBA) and 2-ethylhexyl acrylate (2-EHA). Commercial examples thereof include: EUROPRENE®, available from Enichem Elastomers Americas, Inc; Hypro 200X 168LC VTB, available from Huntsman; Kraton D1155 ES, available from Kraton Corporation; Kurarity LA 4285, a PMMA-PnBA-PMMA triblock copolymer available from Kuraray Co. Ltd.; Blendex 338, available from Galata Chemicals; and, Nipol 1472 X, available from Zeon Chemicals.

As noted, the compositions may optionally contain a toughening rubber in the form of core-shell particles dispersed in the polymer matrix. The term “core shell rubber” or CSR is being employed in accordance with its standard meaning in the art as denoting a rubber particle core formed by a polymer comprising an elastomeric or rubbery polymer as a main ingredient and a shell layer formed by a polymer which is graft polymerized onto the core. The shell layer partially or entirely covers the surface of the rubber particle core in the graft polymerization process. By weight, the core should constitute at least 50 wt. % of the core-shell rubber particle.

The polymeric material of the core should have a glass transition temperature (T_{g}) of no greater than 0° C. and preferably a glass transition temperature (T_{g}) of −20° C. or lower, more preferably −40° C. or lower and even more preferably −60° C. or lower. The polymer of the shell is non-elastomeric, thermoplastic or thermoset polymer having a glass transition temperature (T_{g}) of greater than room temperature, preferably greater than 30° C. and more preferably greater than 50° C.

Without intention to limit the invention, the core may be comprised of: a diene homopolymer, for example, a homopolymer of 1,3-butadiene or 2-methyl-1,3-butadiene (isoprene); a diene copolymer, for example a copolymer of 1,3-butadiene or isoprene with one or more ethylenically unsaturated monomers, such as vinyl aromatic monomers, (meth)acrylonitrile or (meth)acrylates; polymers based on (meth)acrylic acid ester monomers, such as polybutylacrylate; and, polysiloxane elastomers such as polydimethylsiloxane and crosslinked polydimethylsiloxane.

Similarly, without intention to limit the present invention, the shell may be comprised of a polymer or copolymer of one or more monomers selected from: (meth)acrylates, such as methyl methacrylate; vinyl aromatic monomers, such as styrene; vinyl cyanides, such as acrylonitrile; unsaturated acids and anhydrides, such as acrylic acid; and, (meth)acrylamides. The polymer or copolymer used in the shell may possess acid groups that are cross-linked ionically through metal carboxylate formation, in particular through forming salts of divalent metal cations. The shell polymer or copolymer may also be covalently cross-linked by monomers having two or more double bonds per molecule.

It is preferred that any included core-shell rubber particles have an average particle size (d50) of from 10 nm to 300 nm, for example from 50 nm to 250 nm: said particle size refers to the diameter or largest dimension of a particle in a distribution of particles and is measured via dynamic light scattering. For completeness, the present application does not preclude the presence of two or more types of core shell rubber (CSR) particles with different particle size distributions in the composition to provide a balance of key properties of the resultant cured product, including shear strength, peel strength and resin fracture toughness.

The core-shell rubber may be selected from commercially available products, examples of which include: Paraloid EXL 2650A, EXL 2655 and EXL2691 A, available from The Dow Chemical Company; Clearstrength® XT100, available from Arkema Inc.; the Kane Ace® MX series available from Kaneka Corporation, and in particular MX 120, MX 125, MX 130, MX 136, MX 551, MX553; and, METABLEN SX-006 available from Mitsubishi Rayon.

### Rheology Control Agent

The two-part (2K) composition of the present invention is characterized by the presence of rheology control agent. Such an agent may be included in either the first (A) or second (B) parts of the composition or in both parts thereof. When a rheology control agent is provided in both parts of the composition, the identity of the agent in each part is independently determined and, as such, may be the same or different for each part. It is preferred that the first part (A) of the composition comprises rheology control agent.

Said rheology control agent may consist of: electrically non-conductive fillers; electrically conductive fillers; or, mixtures thereof.

The presence of electrically non-conductive fillers in the composition may serve to moderate the viscosity of the composition and to reduce the coefficient of thermal expansion of the adhesive. Broadly, there is no particular intention to limit the shape of the particles employed as non-conductive fillers: particles that are acicular, spherical, ellipsoidal, cylindrical, bead-like, cubic or platelet-like may be used alone or in combination. Moreover, it is envisaged that agglomerates of more than one particle type may be used. Equally, there is no particular intention to limit the size of the particles employed as electrically non-conductive fillers. However, such non-conductive fillers will conventionally have an average volume particle size, as measured by laser diffraction/scattering methods, of from 0.01 to 1500 μm, for example from 0.1 to 1000 μm or from 0.1 to 500 μm.

Exemplary non-conductive fillers include but are not limited to chalk, lime powder, precipitated silica, pyrogenic silica, zeolites, bentonites, magnesium carbonate, diatomite, alumina, clay, talc, sand, quartz, flint, mica, glass powder, zinc oxide and other ground mineral substances. Short fibres such as glass fibres, glass filament, polyacrylonitrile, carbon fibres, polyethylene fibres can also be added.

The use of precipitated and/or pyrogenic silica as a rheology control agent in the present compositions is preferred: such precipitated or pyrogenic silica should desirably have a BET surface area of from 25 to 500 m²/g, for example from 100 to 250 m²/g as measured by means of nitrogen adsorption according to DIN 66131. A commercial example of such a pyrogenic (fumed) silica is Aerosil 200, available from Evonik Industries.

Also suitable as electrically non-conductive fillers are hollow spheres having a mineral shell or a plastic shell. These can be, for example, hollow glass spheres that are obtainable commercially under the trade names Glass Bubbles®. Plastic-based hollow spheres, such as Expancel® or Dualite®, may be used and are described in EP 0 520 426 B1: they are made up of inorganic or organic substances and each have a diameter of 1 mm or less, preferably 500 μm or less, preferably between 100 μm and 200 μm.

Non-conductive fillers which impart thixotropy to the composition may have utility in certain applications: such fillers are also described as rheological adjuvants, e.g. hydrogenated castor oil, fatty acid amides, or swellable plastics such as PVC.

As noted, the compositions according to the present invention may additionally contain electrically conductive fillers as at least part of the rheology control agent. Broadly, there is no particular intention to limit the shape of the particles employed as conductive fillers: particles that are acicular, spherical, ellipsoidal, cylindrical, bead-like, cubic or platelet-like may be used alone or in combination. Moreover, it is envisaged that agglomerates of more than one particle type may be used. Equally, there is no particular intention to limit the size of the particles employed as conductive fillers. However, such conductive fillers will conventionally have an average volume particle size, as measured by laser diffraction/scattering methods, of from 1 to 500 μm, for example from 1 to 200 μm.

Exemplary conductive fillers include, but are not limited to: silver; copper; gold; palladium; platinum; nickel; gold or silver-coated nickel; carbon black; carbon fibre; graphite; aluminium; indium tin oxide; silver coated copper; silver coated aluminium; metallic coated glass spheres; metallic coated filler; metallic coated polymers; silver coated fibre; silver coated spheres; antimony doped tin oxide; conductive nanospheres; nano silver; nano aluminium; nano copper; nano nickel; carbon nanotubes; carbon nanostructures and, mixtures thereof. The use of particulate silver and/or carbon black and/or carbon nanostructure as the conductive filler is preferred.

The total amount of rheology control agent present in the compositions of the present invention will preferably be from 1 to 20 wt. %, and more preferably from 1 to 10 wt. %, based on the total weight of the composition. The desired viscosities of each part of the two-part (2K) composition, and the desired viscosity of the curable composition formed upon mixing said parts, will generally be determinative of the total amount of rheology control agent added. Each part of the two-part composition should desirably have a viscosity of from 3000 to 150,000, for example from 5000 to 100,000: within such a viscosity range, each part should be readily extrudable out of a suitable dispensing apparatus, such as a tube.

### Oxygen Scavenger

The two-part (2K) composition of the present invention is characterized by the presence of at least one oxygen scavenger. The composition may comprise from 0.1 to 5 wt. %, based on the weight of the composition, of said oxygen scavenger. Preferably, the composition comprises from 0.1 to 2 wt. %, for example from 0.1 to 1 wt. % of said oxygen scavenger.

Said oxygen scavenger(s) may be included in either the first (A) or second (B) parts of the composition or in both parts thereof. When an oxygen scavenger is provided in both parts of the composition, the identity of the oxygen scavenger in each part is independently determined and, as such, may be the same or different for each part. It is preferred herein that the first part of the composition comprises an oxygen scavenger.

Said oxygen scavengers are reactive towards activated oxygen species and should also be stable in contact with oxygen or air at room temperature. Suitable examples of oxygen scavengers include: alkylated phenols; alkylated bisphenols; alkylidene bis-, tris- and polyphenols; thio-, bis-, tris- and polyalkylated phenols; sulfur-containing esters; organic phosphines; organic phosphites; organic phosphates; hydroquinones; inorganic compounds, such as sulphates, sulfites, phosphites and nitrites of metals, particularly those of Groups 1 and 2 of the periodic table and first row transition metals, zinc and tin; sulfur-containing compounds, such as thiodipropionic acid and its esters and salts, and thio-bis(ethylene glycol β-aminocrotonate); amino acids, such as cysteine and methionine; and, nitrogen-containing compounds capable of reacting with activated forms of oxygen including primary, secondary and tertiary amines. Preferably, the oxygen scavenger is selected from the group consisting of: triphenylphosphine; triethylphosphite; triisopropylphosphite; triphenylphosphite; tris(nonylphenyl) phosphite; butylated hydroxytoluene; butylated hydroxyanisole; tris(2,4-di-tert-butylphenyl) phosphite; dilaurylthiodipropionate; 2,2-methylene-bis-(6-t-butyl-p-cresol); tetrakis(2,4-d-tert-butylphenyl)4,4′-biphenylene diphosphonate; poly(4-vinylpyridine); and, mixtures thereof.

It is noted that the oxygen scavenger may be in the form of a polymer or oligomer. Such forms may be prepared by covalently bonding a compound—such as those oxygen scavengers listed—to a monomer or co-monomer. A limitation on the molecular size of the oxygen scavenger will be the effect, if any, it has on functional properties of any other polymer with which it is combined.

### Additives and Adjunct Ingredients

Said compositions obtained in the present invention will typically further comprise adjuvants and additives that can impart improved properties to these compositions. For instance, the adjuvants and additives may impart one or more of: improved elastic properties; improved elastic recovery; longer enabled processing time; faster curing time; and, lower residual tack. Included among such adjuvants and additives—which independently of one another may be included in single parts or both parts of a two (2K) part composition—are: activators; plasticizers; stabilizers including UV stabilizers; reactive diluents; non-reactive diluents; drying agents; adhesion promoters; fungicides; flame retardants; dyes; and, colour pigments or colour pastes.

Such adjuvants and additives can be used in such combination and proportions as desired, provided they do not adversely affect the nature and essential properties of the composition. While exceptions may exist in some cases, these adjuvants and additives should not in toto comprise more than 50 wt. % of the total composition and preferably should not comprise more than 20 wt. % of the composition.

For completeness, it is noted that, in general, adjunct materials and additives which contain reactive groups will be blended into the appropriate part of the two (2K) part composition to ensure the storage stability thereof. Unreactive materials may be formulated into either or both of the two parts.

A “plasticizer” for the purposes of this invention is a substance that decreases the viscosity of the composition and thus facilitates its processability. Herein the plasticizer may constitute up to 10 wt. % or up to 5 wt. %, based on the total weight of the composition, and is preferably selected from the group consisting of: polydimethylsiloxanes (PDMS); diurethanes; ethers of monofunctional, linear or branched C₄-C₁₆ alcohols, such as Cetiol OE (obtainable from Cognis Deutschland GmbH, Düsseldorf); esters of abietic acid, butyric acid, thiobutyric acid, acetic acid, propionic acid esters and citric acid; esters based on nitrocellulose and polyvinyl acetate; fatty acid esters; dicarboxylic acid esters; esters of OH-group-carrying or epoxidized fatty acids; glycolic acid esters; benzoic acid esters; phosphoric acid esters; sulfonic acid esters; trimellitic acid esters; epoxidized plasticizers; polyether plasticizers, such as end-capped polyethylene or polypropylene glycols; polystyrene; hydrocarbon plasticizers; chlorinated paraffin; and, mixtures thereof. It is noted that, in principle, phthalic acid esters can be used as the plasticizer but these are not preferred due to their toxicological potential. It is preferred that the plasticizer comprises or consists of one or more polydimethylsiloxane (PDMS).

“Stabilizers” for purposes of this invention are to be understood as antioxidants, UV stabilizers or hydrolysis stabilizers. Herein stabilizers may constitute in toto up to 10 wt. % or up to 5 wt. %, based on the total weight of the composition. Standard commercial examples of stabilizers suitable for use herein include: sterically hindered phenols; thioethers; benzotriazoles; benzophenones; benzoates; cyanoacrylates; acrylates; amines of the hindered amine light stabilizer (HALS) type; phosphorus; sulphur; and, mixtures thereof.

In order to enhance shelf life even further, it is often advisable to further stabilize the compositions of the present invention with respect to moisture penetration through using drying agents. A need also occasionally exists to lower the viscosity of an adhesive composition according to the present invention for specific applications, by using reactive diluent(s). The total amount of reactive diluents present will typically be from 0 to 15 wt. %, for example from 0 to 5 wt. %, based on the total weight of the composition.

In certain embodiments, it may be of value to include dyes within the two-part (2K) composition. Desirably, the first part of the composition should contain the added dyes. The skilled person is considered able to select appropriate dyes based upon inter alia the desired color of the cured adhesive and the light fastness, cost, toxicological profile and solubility of the dyes in the carrying medium. Generally suitable dyes will be selected from the classes of azo, anthraquinone and triphenylmethane type dyes and the dyes may be chemically modified so as to increase their solubility in the carrying medium or to reduce their adsorption by the substrate surface to which the adhesive is applied. Exemplary dyes which may be mentioned include PV Fast Blue BG and PV Fast Red B available from Clariant K.K.

The presence of solvents and non-reactive diluents in the compositions of the present invention is also not precluded where this can usefully moderate the viscosities thereof. For instance, but for illustration only, the compositions may contain one or more of: xylene; 2-methoxyethanol; dimethoxyethanol; 2-ethoxyethanol; 2-propoxyethanol; 2-isopropoxyethanol; 2-butoxyethanol; 2-phenoxyethanol; 2-benzyloxyethanol; benzyl alcohol; ethylene glycol; ethylene glycol dimethyl ether; ethylene glycol diethyl ether; ethylene glycol dibutyl ether; ethylene glycol diphenyl ether; diethylene glycol; diethylene glycol-monomethyl ether; diethylene glycol-monoethyl ether; diethylene glycol-mono-n-butyl ether; diethylene glycol dimethyl ether; diethylene glycol diethyl ether; diethylene glycoldi-n-butylyl ether; propylene glycol butyl ether; propylene glycol phenyl ether; dipropylene glycol; dipropylene glycol monomethyl ether; dipropylene glycol dimethyl ether; dipropylene glycoldi-n-butyl ether; N-methylpyrrolidone; diphenylmethane; diisopropylnaphthalene; petroleum fractions such as Solvesso® products (available from Exxon); alkylphenols, such as tert-butylphenol, nonylphenol, dodecylphenol and 8,11,14-pentadecatrienylphenol; styrenated phenol; bisphenols; aromatic hydrocarbon resins especially those containing phenol groups, such as ethoxylated or propoxylated phenols; adipates; sebacates; phthalates; benzoates; organic phosphoric or sulfonic acid esters; and sulfonamides.

The above aside, it is preferred that said non-reactive diluents constitute in toto less than 10 wt. %, in particular less than 5 wt. % or less than 2 wt. %, based on the total weight of the composition.

### Illustrative Embodiment of the Two-Part (2K) Composition

In an exemplary embodiment of the present invention, the two-part (2K) adhesive composition comprises:
a first part (A) comprising, based on the weight of said first part:
   from 30 to 60 wt. %, preferably from 35 to 50 wt. %, of (meth)acrylate monomer, wherein said (meth)acrylate monomer comprises at least one C₁-C₆ alkyl ester of (meth)acrylic acid;
   from 5 to 15 wt. %, preferably from 6 to 12 wt. %, of co-polymerizable acid, wherein said co-polymerizable acid is selected from the group consisting of methacrylic acid, acrylic acid, itaconic acid, maleic acid, aconitic acid, crotonic acid, fumaric acid and mixtures thereof; and,
   from 5 to 15 wt. %, preferably from 6 to 12 wt. % of electrolyte, wherein said electrolyte is selected from 1-butyl-3-methylimidazolium bis(trifluoromethylsulfonyl)imide and 1-dodecyl-3-methylimidazolium bis(trifluoromethylsulfonyl)imide and mixtures thereof; and,
a second part (B) comprising, based on the weight of said second part:
   from 10 to 40 wt. % preferably from 20 to 40 wt. % of a first curing agent which comprises or consists of at least one free radical initiator which decomposes under the action of heat to provide free radicals;
   from 0.01 to 1 wt. %, preferably from 0.01 to 0.5 wt. % of a second curing agent which consists of at least one compound which is a salt or a complex of a transition metal selected from the group consisting of Fe, Co, V, Mn and Cu;
   from 5 to 20 wt. %, preferably from 5 to 15 wt. % of a wax; and,
   from 30 to 60 wt. %, preferably from 40 to 60 wt. % of a solubilizer,
wherein said first part (A) of the two-part (2K) adhesive composition further comprises, based on the total weight of the composition:
   from 10 to 40 wt. %, preferably from 20 to 40 wt. % of a toughener selected from the group consisting of non-reactive elastomers, core-shell rubber particles and mixtures thereof;
   from 0.1 to 2 wt. %, preferably from 0.1 to 1 wt. % of an oxygen scavenger; and,
   from 1 to 10 wt. % of a rheology control agent,
further wherein said first (A) and second (B) parts are mixed at a ratio by weight of A:B of from 15:1 to 5:1, preferably of from 12:1 to 8:1 and most preferably of 10:1.

It is preferred in this embodiment that the first curing agent is a peroxide or hydroperoxide compound selected from the group consisting of tert-butyl peroxide, tert-butyl perbenzoate, cumene hydroperoxide, tert-butyl peroxybenzoate, diacetyl peroxide, benzoyl peroxide, tert-butyl peracetate, lauryl peroxide and mixtures thereof: a particular preference for benzoyl peroxide is noted. Independently of or additional to this statement of preference for the first curing agent, the second curing agent preferably comprises of consists of at least one iron-based compound selected from the group consisting of ferrocene, iron(II) acetylacetonate and ammonium iron(3+) hexakis(cyano-C)ferrate(4−).

It is further preferred in this embodiment that the toughener comprises or consists of at least one non-reactive elastomer.

### Methods and Applications

To form the defined two part (2K) curable compositions, the reactive parts are brought together and mixed in such a manner as to induce the hardening thereof. The reactive compounds should be mixed under sufficient shear forces to yield a homogeneous mixture that is preferably bubble (foam) free upon mixing. It is considered that this can be achieved without special conditions or special equipment. That said, suitable mixing devices might include: static mixing devices; magnetic stir bar apparatuses; wire whisk devices; augers; batch mixers; planetary mixers; C.W. Brabender or Banburry® style mixers; and, high shear mixers, such as blade-style blenders and rotary impellers.

For small-scale applications in which volumes of less than 2 litres will generally be used, the preferred packaging for the two part (2K) compositions will be side-by-side double cartridges or coaxial cartridges, in which two tubular chambers—typically of equal volume—are arranged alongside one another or inside one another and are sealed with pistons: the driving of these pistons allows the parts to be extruded from the cartridge, advantageously through a closely mounted static or dynamic mixer. For larger volume applications, the two parts of the composition may advantageously be stored in drums or pails: in this case the two parts are extruded via hydraulic presses, in particular by way of follower plates, and are supplied via pipelines to a mixing apparatus which can ensure fine and highly homogeneous mixing of the two parts. In any event, for any package it is important that the parts be disposed with an airtight and moisture-tight seal, so that both parts can be stored for a long time, ideally for 12 months or longer.

Non-limiting examples of two-part dispensing apparatuses and methods that may be suitable for the present invention include those described in U.S. Pat. Nos. 6,129,244 and 8,313,006.

Depending upon the desired properties of the cured composition, the two parts will conventionally be mixed at a ratio by weight of Part A:Part B of from 20:1 to 1:1, for example 15:1 to 5:1 or from 12:1 to 8:1. A particularly preferred embodiment of the composition has a ratio by weight of Part A:Part B of 10:1.

In accordance with the broadest process aspects of the present invention, the above-described compositions are applied to the material layer(s) and then cured in situ. Prior to applying the compositions, it is often advisable to pre-treat the relevant surfaces to remove foreign matter there from: this step can, if applicable, facilitate the subsequent adhesion of the compositions thereto. Such treatments are known in the art and can be performed in a single or multi-stage manner constituted by, for instance, the use of one or more of: an etching treatment with an acid suitable for the substrate and optionally an oxidizing agent; sonication; plasma treatment, including chemical plasma treatment, corona treatment, atmospheric plasma treatment and flame plasma treatment; immersion in a waterborne alkaline degreasing bath; treatment with a waterborne cleaning emulsion; treatment with a cleaning solvent, such as carbon tetrachloride or trichloroethylene; and, water rinsing, preferably with deionized or demineralized water. In those instances where a waterborne alkaline degreasing bath is used, any of the degreasing agent remaining on the surface should desirably be removed by rinsing the substrate surface with deionized or demineralized water.

The compositions are then applied to the preferably pre-treated surfaces of the substrate by conventional application methods such as: brushing; roll coating; doctor-blade application; printing methods; and, spraying methods, including but not limited to air-atomized spray, air-assisted spray, airless spray and high-volume low-pressure spray.

As noted above, the present invention provides a bonded structure comprising: a first material layer having an electrically conductive surface; and, a second material layer having an electrically conductive surface, wherein the cured debondable two-part (2K) adhesive composition as defined hereinabove and in the appended claims is disposed between said first and second material layers. To produce such a structure, the adhesive composition may be applied to at least one internal surface of the first and/or second material layer and the two layers then subsequently contacted, such that the curable and debondable adhesive composition according to the present invention is interposed between the two layers.

It is recommended that the compositions be applied to a surface at a wet film thickness of from 10 to 500 μm. The application of thinner layers within this range is more economical and provides for a reduced likelihood of deleterious thick cured regions. However, great control must be exercised in applying thinner coatings or layers so as to avoid the formation of discontinuous cured films.

The curing of the applied compositions of the invention typically occurs at temperatures in the range of from 20° C. to 200° C., preferably from 25° C. to 100° C., for example from 25 to 80° C. or from 25 to 65° C. The temperature that is suitable depends on the specific compounds present and the desired curing rate and can be determined in the individual case by the skilled artisan, using simple preliminary tests if necessary.

Of course, curing at lower temperatures within the aforementioned ranges is advantageous as it obviates the requirement to substantially heat or cool the mixture from the usually prevailing ambient temperature. Where applicable, however, the temperature of the mixture formed from the respective parts of a two (2K) part composition may be raised above the mixing temperature and/or the application temperature using conventional means including microwave induction.

The present invention will be described with reference to the appended drawings in which:

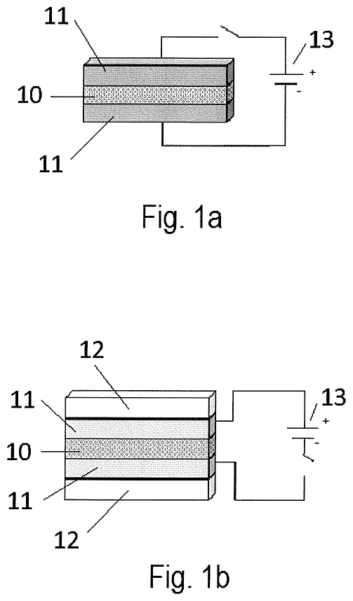

FIG. 1a illustrates a bonded structure in accordance with a first embodiment of the present invention.

FIG. 1b illustrates a bonded structure in accordance with a second embodiment of the present invention.

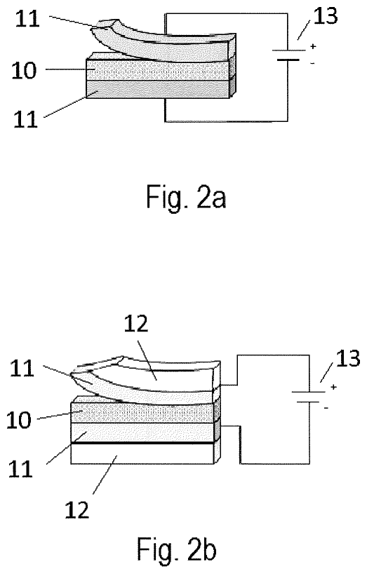

FIG. 2a illustrates the initial debonding of the structure of the first embodiment upon passage of a current across that structure.

FIG. 2b illustrates the initial debonding of the structure of the second embodiment upon passage of a current across that structure.

As shown in FIG. 1a appended hereto, a bonded structure is provided in which a layer of cured adhesive (10) is disposed between two conductive substrates (11). A layer of non-conductive material (12) may be disposed on the conductive substrates (11) to form the more complex bonded structure as depicted in FIG. 1b. Each layer of conductive substrate (11) is in electrical contact with an electrical power source (13) which may be a battery or an AC-driven source of direct current (DC). The positive and negative terminals of that power source (13) are shown in one fixed position but the skilled artisan will of course recognize that the polarity of the system can be reversed.

The two conductive substrates (11) are shown in the form of a layer which may be constituted by inter alia: a metallic film; a metallic sheet; a metallic mesh or grid; deposited metal particles; a resinous material which is rendered conductive by virtue of conductive elements disposed therein; or, a conducting oxide layer. As exemplary conductive elements there may be mentioned silver filaments, single-walled carbon nanotubes and multi-walled carbon nanotubes. As exemplary conducting oxides there may be mentioned: doped indium oxides, such as indium tin oxide (ITO); doped zinc oxide; antimony tin oxide; cadmium stannate; and, zinc stannate. The selection of the conductive material aside, the skilled artisan will recognize that the efficacy of the debonding operation may be diminished where the conductive substrates (11) are in the form of a grid or mesh which offers limited contact with the layer of cured adhesive (10).

When an electrical voltage is applied between each conductive substrate (11), current is supplied to the adhesive composition (10) disposed there between. This induces electrochemical reactions at the interface of the substrates (11) and the adhesive composition, which electrochemical reactions are understood as oxidative at the positively charged or anodic interface and reductive at the negatively charged or cathodic interface. The reactions are considered to weaken the adhesive bond between the substrates allowing the easy removal of the debondable composition from the substrate.

As depicted in FIGS. 2a and 2b, the debonding occurs at the positive interface, that interface between the adhesive composition (10) and the electrically conductive surface (11) that is in electrical contact with the positive electrode. By reversing current direction prior to separation of the substrates, the adhesive bond may be weakened at both substrate interfaces.

It is however noted that the composition of the adhesive layer (10) may be moderated so that debonding occurs at either the positive or negative interface or simultaneously from both. For some embodiments a voltage applied across both surfaces so as to form an anodic interface and a cathodic interface will cause debonding to occur simultaneously at both the anodic and cathodic adhesive/substrate interfaces. In an alternative embodiment, reversed polarity may be used to simultaneously disbond both substrate/adhesive interfaces if the composition does not respond at both interfaces to direct current. The current can be applied with any suitable waveform, provided that sufficient total time at each polarity is allowed for debonding to occur. Sinusoidal, rectangular and triangular waveforms might be appropriate in this regard and may be applied from a controlled voltage or a controlled current source.

Without intention to limit the present invention, it is considered that the debonding operation may be performed effectively where at least one and preferably both of the following conditions are instigated: a) an applied voltage of from 0.5 to 100 V; and, b) the voltage being applied for a duration of from 1 second to 60 minutes. Where the release of the conductive substrate from the cured adhesive is to be facilitated by the application of a force—exerted via a weight or a spring, for instance—the potential might only need to be applied for the order of seconds. In some embodiments potential of 5V for a duration of 10 minutes is sufficient to have a debonding effect.

It is desired that after the debonding, the adhesive composition is solely on a first substrate or a second substrate, meaning that one of the substrates is substantially free of adhesive.

The following examples are illustrative of the present invention and are not intended to limit the scope of the invention in any way.

### EXAMPLES

The following materials were employed in the Examples:

| | |
|---|---|
| 1-butyl-3-methylimidazolium bis(trifluoromethylsulfonyl) imide: | Available from Sigma Aldrich. |
| 1-docecyl-3-methylimidazolium bis(trifluoromethylsulfonyl) imide: | Available from Sigma Aldrich. |
| Trihexyltetradecylphosphonium bis(trifluoromethylsulfonyl)amide: | Available from Sigma Aldrich |
| Cyphos IL 109: | Available from Solvay |
| Methyl methacrylate: | Available from Sigma Aldrich. |
| Methacrylic acid: | Available from Acros Organics. |
| Phosphoric acid 2-hydroxyethyl methacrylate ester: | Available from Sigma Aldrich. |
| 2,2′-(4-methylphenylimino)diethanol: | Available from Sigma Aldrich. |
| Garamite 1958: | Powdered rheology additive based on |
| | organophilic phyllosilicates, available from |
| | BYK. |
| Aerosil 200: | Hydrophilic fumed silica, available from |
| | Evonik Industries. |
| Zinc oxide nanopowder: | Available from Sigma Aldrich. |
| Kraton D 1155 ES: | Linear block copolymer based on styrene |
| | and butadiene with bound styrene of 40% |
| | mass, available from Kraton Corporation. |
| Kurarity LA 4285: | All acrylic block copolymer (MAM), available |
| | from Kuraray Co. Ltd. |
| Nipol 1472 X: | Acrylonitrile butadiene rubber, available |
| | from Zeon Chemicals. |
| Hypro 2000X168 LC VTB: | Methacrylate terminated polybutadiene |
| | rubber, available from Huntsman. |
| Blendex 338: | Ultra high rubber acrylonitrile butadiene |
| | rubber (ABS) resin, available from Galata |
| | Chemicals. |
| Pluracol V10: | Ethylene oxide-propylene oxide copolymer |
| | ether with trimethylolpropane (CAS No. |
| | 52624-57-4) available from BASF SE. |
| Benzoflex 2088: | Blend of diethylene glycol benzoate, |
| | dipropylene glycol benzoate and triethylene |
| | glycol benzoate available from Eastman |
| | Chemical Company. |
| Triphenylphosphine: | Available from Merck KGaA |
| Wax component: | Paraffin wax, available from International |
| | Group Inc. |
| Ferrocene: | available from Merck. |
| DER 331: | Bisphenol-A epoxy resin, available from Olin |
| | Corporation. |
| Benzoyl peroxide (75%): | Powder, available from Arkema Inc. |

The following test methods have been used to characterize the two-part formulations:

Tensile Lap Shear (TLS) Test: The substrates tested were nickel (thickness 1.5 mm), aluminium (AA6016, thickness 1.25 mm) and stainless steel (1.4301, thickness 1.5 mm). The substrate was cut into 2.5 cm×10 cm in size for tensile testing. Tensile lap shear (TLS) test was performed at room temperature based upon EN 1465:2009 (German version) Adhesives—Determination of Tensile Lap-shear Strength of Bonded Assemblies. The bond overlapping area for each stated substrate was 2.5 cm×1.0 cm (1″×1″) with a bond thickness of 150 microns. The applied two-component (2K) adhesive compositions were cured in the overlapping region at 80° C. for 30 minutes. The test specimens were placed in the grips of a universal testing machine and pulled at 10 mm/min until failure occurs. The grips used to secure the ends of the assembly must align so that the applied force is applied through the centerline of the specimen. The type of failure can be either adhesive—wherein the adhesive separates from one of the substrates—or cohesive wherein the adhesive ruptures within itself.

Aging Test: The substrates tested were aluminium (AA6016, thickness 1.25 mm) and stainless steel (1.4301, thickness 1.5 mm). The substrate was cut into 2.5 cm×10 cm in size for tensile testing. The bond overlapping area for each stated substrate was 2.5 cm×1.0 cm with a bond thickness of 150 microns. The applied two-component (2K) adhesive compositions were cured in the overlapping region for 20 minutes at either 45° C. (Example 1) or 80° C. (Example 2). The specimens were stored in a climate chamber at 90% relative humidity and 65° C.: at defined points in the storage (1 day, 7 days, 14 days and 21 days) tensile lap shear (TLS) tests were performed at room temperature based as per the above methodology (EN 1465:2009, German Version). The test specimens were placed in the grips of a universal testing machine and pulled at 10 mm/min until failure occurs.

Thin Bond Line Test: The substrate tested was stainless steel (1.4301, thickness 1.5 mm). The substrate was cut into 2.5 cm×10 cm in size for tensile testing. The bond overlapping area for each stated substrate was 2.5 cm×0.25 cm with a bond thickness of 150 microns. The applied two-component (2K) adhesive compositions were cured in the overlapping region at 80° C. for 20 minutes. Tensile lap shear (TLS) tests were performed at room temperature based as per the above methodology (EN 1465:2009, German Version). The test specimens were placed in the grips of a universal testing machine and pulled at 10 mm/min until failure occurs.

T-Peel Resistance (N/mm): The testing of this parameter was based on the following standards: ASTM D1876 Peel Resistance of Adhesives; ISO 11339 Adhesives 180° Peel Test for Flexible-to-Flexible Bonded Assemblies; DIN 53282 Testing of Adhesives for Metals and Adhesively Bonded Metal Joints. At least three test specimens were assembled and tested for each test point. Bonds were prepared using aluminium peel substrates which had been wiped with acetyl acetate to remove dirt or grease therefrom. The composition to be evaluated was applied to both sides of the peel strip specimens. Starting at one end, the composition was spread with an applicator stick to ensure coverage of a 25×50 mm area. A second peel strip specimen was then mated with the coated peel strip specimen. The obtained assembly was clamped using one clamp on each side of the assembly and one on the end of the assembly—for a total of three clamps—to ensure that the clamping load was evenly distributed. The composition was then cured within the assembly at 80° C. for 20 minutes. The clamps were removed after 24 hours and the bonds were pulled to provide T-peel results.

Impact Strength (N/mm): The testing of this parameter was based on the following standards: ASTM 3762 Standard Test Method for Adhesive-Bonded Surface Durability of Aluminum (Wedge Test). In this test, an aluminium specimen was prepared in accordance with ASTM D1002. According to these standards, a pendulum impact tester was used, said tester being equipped with a retaining bolt, active strain gauges and hammer fin and further equipped with instrumentation for determining force-time curves and force-deflection curves. For each specimen, the applied two-component (2K) adhesive compositions were cured in the overlapping region at 80° C. for 20 minutes. The specimen was inserted into a wedge test fixture with unbonded ends protruding enough to interleave a wedge between the adherends. The test fixture was then assembled into the specimen retaining bolt, which bolt was first tightened by hand then tightened an additional quarter turn using an appropriate tool. The specimen was then allowed to stabilize at 25° C. and 50% relative humidity before applying the impact, for which an impact velocity of 2.3 ms⁻¹ was specified. During the impact event, the transducer signal was automatically and unselectively detected by microprocessor and recorded; the force-time (or force-displacement) data was subsequently manipulated separately.

Film Properties: The modulus (MPa), elongation at break and tensile strength (MPA) of the adhesive film were tested in accordance with ASTM D638-14 Standard Test Method for Tensile Properties of Plastics. Adhesive films having a thickness of 2.3 mm were prepared by curing the two-component (2K) adhesive compositions at 80° C. for 20 minutes.

Viscosity: Measurements of the exemplified compositions were performed at a shear rate of 20 s⁻¹.

Part (B) of the two-component composition of each composition 1-6 was prepared in accordance with Table 1 herein below:

TABLE 1

| | Part B |
|---|---|
| Ingredient | % by Weight of Stated Part |
| Pluracol V10 | 10.0 |
| Benzoflex 2088 | 20.4 |
| Benzoyl Peroxide (75%) | 37.0 |
| D.E.R 331 | 21.0 |
| Wax component | 11.5 |
| Ferrocene | 0.1 |
| Total | 100 |

### Example 1

Part (A) of the composition 1 of Example 1 was prepared in accordance with Table 2 herein below.

TABLE 2

| | Part A |
|---|---|
| Component | Weight [g] |
| Methylmethacrylate | 45.08 |
| Methacrylic acid | 9.80 |
| Phosphoric acid 2-hydroxyethyl methacrylate ester | 1.47 |
| 2,2′-(4-methylphenylimino) diethanol | 1.47 |
| 1-butyl-3-methylimidazolim bis(trifluoromethylsulfonyl)imide | 9.80 |
| Aerosil 200 | 1.96 |
| Garamite 1958 | 2.00 |
| Zinc oxide nanopowder | 0.98 |
| Kurarity LA 4285 | 13.43 |
| Nipol 1472X | 3.92 |
| Hypro 2000X 168 LC Polymer-VTB | 5.88 |
| Blendex 338 | 3.92 |
| Wax component | 0.29 |
| Total | 100 |

The parts were loaded at a ratio by weight (A:B) of 10:1 into separate compartments of a 50 g cartridge and sealed at both ends. The cartridge was then loaded into a cartridge-gun and a mixing tip was installed on the front end. By application of constant pressure on the trigger, the two parts were pushed into the mixing tip to ensure sufficient mixing before application to the stated substrate.

For each substrate, tensile lap shear strength, aging, peel strength, wedge impact and film property tests were performed as above. The applied two-part (2K) adhesive compositions were cured in the overlapping region by the application of the temperature conditions described for each test. Where applicable, the samples were stored in a climate chamber prior to testing.

The results are documented in Table 3 herein below.

TABLE 3

| | Relevant Conditions | | |
|---|---|---|---|
| Test Performed | or Substrate | Unit | Value |
| Lap Shear Test | Stainless Steel | MPa | 23.7 |
| | Nickel | MPa | 17.0 |
| Aging Test | 1 Day (24 hours) | MPa | 23.5 |
| at 90% RH, 65° C.; | 7 Days (168 hours) | MPa | 18.4 |
| Al/Al | 21 Days (504 hours) | MPa | 19.1 |
| Aging Test | 1 Day (24 hours) | MPa | 14.7 |
| at 90% RH, 65° C.; | 7 Days (168 hours) | MPa | 15.9 |
| Steel/Steel | 14 Days (336 hours) | MPa | 12.6 |
| | 21 Days (504 hours) | MPa | 11.8 |
| T-Peel strength | Al/Al | N/mm | 5.9 |
| Wedge Impact | Al/Al | N/mm | 0.4 |
| Film Properties | Modulus | MPa | 1470 |
| | Elongation | % | 5.3 |
| | Tensile Strength | MPa | 20.6 |

For adhesively bonded stainless-steel substrates, lap shear strength (MPa) was investigated under the debonding conditions provided in Table 4 hereinbelow, specifically with or without the application of electrical potential across the bonded area. Where applicable: the aged specimens were stored in a climate chamber at 90% relative humidity and 65° C.; and, a constant potential (30 V) was applied across the overlapping bonded area over a period of 20 minutes.

TABLE 4

| Age | Bond Strength | Bond Strength after 30 |
|---|---|---|
| (hours) | (MPa) | V, 20 minutes (MPa) |
| 0 | 21.84 (±1.00) | 4.74 (±1.70) |
| 48 | 19.73 (±1.50) | 4.17 (±0.50) |

### Example 2

Part (A) of the composition of Example 2 was prepared in accordance with Table 5 herein below.

TABLE 5

| | Comp. 2 | Comp. 3 | Comp. 4 | Comp. 5 | Comp. 6 |
|---|---|---|---|---|---|
| | Part A | Part A | Part A | Part A | Part A |
| Component | Weight [g] | Weight [g] | Weight [g] | Weight [g] | Weight [g] |
| Methylmethacrylate | 45.02 | 45.08 | 45.08 | 45.08 | 42.00 |
| Methacrylic acid | 9.79 | 9.80 | 9.80 | 9.80 | 9.38 |
| Phosphoric acid 2-hydroxyethyl | 1.47 | 1.47 | 1.47 | 1.47 | 1.00 |
| methacrylate ester | | | | | |
| 2,2′-(4-methylphenylimino) | 1.47 | 1.47 | 1.47 | 1.47 | 1.50 |
| diethanol | | | | | |
| Diethylmethylsulfonium | 12.00 | 9.80 | | | |
| bis(trifluoromethylsulfonyl)imide | | | | | |
| Trihexyltetradecylphosphonium | | | 9.80 | | |
| bis(trifluoromethylsulfonyl)amide | | | | | |
| 1-Dodecyl-3-methylimidazolium | | | | 9.80 | |
| bis(trifluoromethylsulfonyl)imide | | | | | |
| Cyphos IL 109 | | | | | 10.42 |
| Aerosil 200 | 1.95 | 1.96 | 1.96 | 1.96 | 2.00 |
| Garamite 1958 | | | 2.00 | 2.00 | |
| Zinc oxide nanopowder | 1.00 | 0.98 | 0.98 | 0.98 | |
| Kurarity LA 4285 | 13.00 | 13.43 | 13.43 | 13.43 | |
| Nipol 1472X | 4.00 | 3.92 | 3.92 | 3.92 | 6.25 |
| Hypro 2000X 168 LC Polymer-VTB | 6.00 | 5.88 | 5.88 | 5.88 | 10.43 |
| Triphenylphosphine | | | | | 0.52 |
| Kraton D 1155 ES | | | | | 16.5 |
| Blendex 338 | 4.00 | 3.92 | 3.92 | 3.92 | |
| Wax component | 0.30 | 0.29 | 0.29 | 0.29 | |
| Total | 100 | 100 | | | |

The parts were loaded at a ratio by weight (A:B) of 10:1 into separate compartments of a 50 g cartridge and sealed at both ends. The cartridge was then loaded into a cartridge-gun and a mixing tip was installed on the front end. By application of constant pressure on the trigger, the two parts were pushed into the mixing tip to ensure sufficient mixing before application to the stated substrate.

For each substrate, tensile lap shear strength, aging, peel strength, wedge impact and film property tests were performed as above. The applied two-part (2K) adhesive compositions were cured in the overlapping region by the application of the temperature conditions described for each test. Where applicable, the samples were stored in a climate chamber prior to testing.

Test results for composition 2 are reported below in table 6.

TABLE 6

| Age at 90% | | Bond Strength | Age at 90% |
|---|---|---|---|
| RH, 65° C. | | after 30 V, | RH, 65° C. |
| Steel/Steel | Bond Strength | 20 minutes | Steel/Steel |
| (hours) | (MPa) | (MPa) | (hours) |
| 0 | 16.29 (±0.75) | 4.64 (±1.14) | 0 |
| 168 | 12.31 (±1.01) | 1.78 (±0.85) | 168 |
| 336 | 14.58 (±1.60) | 3.01 (±0.44) | 336 |

Test results for composition 3 are reported below in table 7.

TABLE 7

| Age at 90% RH, | | Bond Strength after |
|---|---|---|
| 65° C. Steel/Steel | Bond Strength | 30 V, 20 minutes |
| (hours) | (MPa) | (MPa) |
| 168 | 19.33 (±0.35) | 3.97 (±0.89) |
| 336 | 20.73 (±0.50) | 4.24 (±0.87) |
| 504 | 18.49 (±0.48) | 3.53 (±0.26) |

Test results for composition 4 are reported below in table 8.

TABLE 8

| | Relevant Conditions | | |
|---|---|---|---|
| Test Performed | or Substrate | Unit | Value |
| Lap Shear Test | Stainless Steel | MPa | 16.58 |
| Aging Test at | 7 Days (168 hours) | MPa | 13.64 |
| 90% RH, 65° C.; | 14 Days (336 hours) | MPa | 13.49 |
| | 21 Days (504 hours) | MPa | 12.88 |

Test results for composition 5 are reported below in table 9.

TABLE 9

| Age at 90% RH, | | Bond Strength after |
|---|---|---|
| 65° C. Steel/Steel | Bond Strength | 30 V, 20 minutes |
| (hours) | (MPa) | (MPa) |
| 0 | 20.29 (±0.98) | 4.42 (±1.81) |
| 168 | 15.65 (±2.61) | 0.25 (±0.06) |
| 336 | 18.23 (±2.29) | 1.46 (±0.29) |
| 504 | 14.96 (±0.25) | 1.24 (±0.47) |

Test results for composition 6 are reported below in table 10.

TABLE 10

| | | Bond Strength after |
|---|---|---|
| Age | Bond Strength | 30 V, 20 minutes |
| (hours) | (MPa) | (MPa) |
| 0 | 18.21 (±0.63) | 9.22 (±1.24) |

### Example 3

Compositions 7, 9 and 9 of Example 4 were prepared in accordance with Table 11 herein below.

TABLE 11

| | Comp. 7 | Comp. 8 | Comp. 9 |
|---|---|---|---|
| Ingredient | (g) | (g) | (g) |
| Part A | | | |
| HPMA | 46.00 | 46.00 | 46.00 |
| Nipol 1472X | 4.00 | 4.00 | 4.00 |
| Kurarity LA 4285 | 13.60 | 13.60 | 13.60 |
| Blendex 338 | 4.00 | 4.00 | 4.00 |
| HYPRO 2000X168LC | 6.00 | 6.00 | 6.00 |
| Polymer - VTB | | | |
| Harcryl 1228 | 1.70 | 1.70 | 1.70 |
| MAA | 10.00 | 10.00 | 10.00 |
| 2,2′-(4-Methylphenylimino) | 1.70 | 1.70 | 1.70 |
| diethanol | | | |
| ZnO | 1.00 | 1.00 | 1.00 |
| Aerosil 200 | 2.00 | 2.00 | 2.00 |
| BMIM NTf2 | 10.00 | | |
| DDMIM NTf2 | | 10.00 | |
| Cyphos IL 109 | | | 10.00 |
| Part B | | | |
| Loctite HHD 8540 Part B | | | |

The individual part A of the adhesive was first prepared by adding all ingredients in a single pot and stirring it overnight to dissolve all ingredients. The final adhesives were obtained by adding the individual parts A and B in a 10:1 ratio, respectively, and speedmixing it at 3000 rpm for 15 seconds.

The application substrate for the compositions was stainless steel (EN 1.4301) and were cut into pieces of 2.5 cm×10 cm in size, and 1.50 mm in thickness. To control the thickness of the coating composition applied between both substrates, glass beads are used as spacers having a diameter of 100 to 200 microns. Tensile lapshear (TLS) tests were performed at room temperature based on EN 1465:2009 (German version) Based on Adhesives—Determination of tensile lap-shear strength of bonded assemblies.

The bond overlapping area for each stated substrate was 2.5 cm×1.0 cm with a bond thickness of 0.1 cm (40 mil). The applied adhesive compositions were cured in the overlapping region by first leaving in ambient conditions for 1 hour and subsequently applying a temperature of 80° C. for 30 minutes. The bonded structures were then stored at room temperature for 24 hours prior to initial tensile testing or storing them in a climate chamber for accelerated ageing studies at 65° C. and 90% relative humidity.

Tensile lapshear strength values were collected after said 24 hours storage period both prior and subsequent application of a constant potential of 50 V across the adhesive layer for a duration of 30 minutes, and after storage in the climate chamber at 65° C. and 90% relative humidity, respectively. The results are documented in Table 12 herein below.

TABLE 12

| | Initial | | 1 Week Storage | | 3 Weeks Storage | |
|---|---|---|---|---|---|---|
| | | Shear | | Shear | | Shear |
| | Shear | Strength | Shear | Strength | Shear | Strength |
| | Strength | (MPa) | Strength | (MPa) | Strength | (MPa) |
| Adhesive | (MPa) | 50 V, | (MPa) | 50 V, | (MPa) | 50 V, |
| composition | 0 V | 30 min | 0 V | 30 min | 0 V | 30 min |
| Comp. 7 | 15.90 ± | 5.41 ± | 12.71 ± | 9.19 ± | 10.39 ± | 2.56 ± |
| | 0.12 | 2.00 | 0.32 | 0.60 | 0.06 | 0.33 |
| Comp. 8 | 16.12 ± | 1.16 ± | 11.70 ± | 1.53 ± | 11.43 ± | 2.32 ± |
| | 0.75 | 0.82 | 0.98 | 0.53 | 0.52 | 0.38 |
| Comp. 9 | 15.57 ± | 2.13 ± | 14.59 ± | 2.35 ± | 12.96 ± | 5.37 ± |
| | 1.13 | 1.30 | 0.96 | 0.63 | 0.16 | 0.48 |

Table 12 summarizes the results obtained for different ionic liquids (BMIM NTf2, DDMIM NTf2 and Cyphos IL 109), and all compositions 7-9 show a good stability after storage at 65° C. and 90% relative humidity for 3 weeks, but the best is for composition 9 with Cyphons IL 109. The electrochemical delamination performance is varying. DDMIM NTf2 in composition 9 shows the best overall delamination performance. BMIM NTf2 shows a bad initial delamination process but still above 50% drop compared to the same system with MMA as acrylic monomer. After storage at 65° C. and 90% relative humidity, surprisingly, the delamination gets worse after 1 week but after 3 weeks, it drastically improves. Cyphos IL 109, on the other hand, shows an opposite behaviour with a very good delamination initially, but gets worse after 3 weeks of storage at 65° C. and 90% relative humidity.

### Example 4

Compositions 10-13 of Example 5 were prepared in accordance with Table 13 herein below. R1 is a reference composition.

TABLE 13

| | | Comp. | Comp. | Comp. | Comp. |
|---|---|---|---|---|---|
| | R1 | 10 | 11 | 12 | 13 |
| Ingredient | (g) | (g) | (g) | (g) | (g) |
| Part A | | | | | |
| HPMA | 46.00 | 46.00 | 46.00 | 46.00 | 46.00 |
| Nipol 1472X | 4.00 | 4.00 | 4.00 | 4.00 | 4.00 |
| Kurarity LA 4285 | 13.60 | 13.60 | 13.60 | 13.60 | 13.60 |
| Blendex 338 | 4.00 | 4.00 | 4.00 | 4.00 | 4.00 |
| HYPRO 2000X168LC | 6.00 | 6.00 | 6.00 | 6.00 | 6.00 |
| Polymer - VTB | | | | | |
| Harcryl 1228 | 1.70 | 1.70 | 1.70 | 1.70 | 1.70 |
| MAA | 10.00 | 10.00 | 10.00 | 10.00 | 10.00 |
| 2,2′-(4-Methylphenylimino) | 1.70 | 1.70 | 1.70 | 1.70 | 1.70 |
| diethanol | | | | | |
| ZnO | 1.00 | 1.00 | 1.00 | 1.00 | 1.00 |
| Aerosil 200 | 2.00 | 2.00 | 2.00 | 2.00 | 2.00 |
| Cyphos IL 109 | | 4.00 | 6.00 | 8.00 | 10.00 |
| Part B | | | | | |
| Loctite HHD 8540 Part B | | | | | |

Starting from the good performance of example 4 composition 9, the composition was replicated but by varying the amount of ionic liquid Cyphos IL 109 (0, 4.26, 6.25, 8.16 and 10 wt %). The individual part A of the adhesive was first prepared by adding all ingredients in a single pot and stirring it overnight to dissolve all ingredients. The final adhesives were obtained by adding the individual parts A and B in a 10:1 ratio, respectively, and speed mixing it at 3000 rpm for 15 seconds. The application substrate for the formulations was stainless steel (EN 1.4301) and were cut into pieces of 2.5 cm×10 cm in size, and 1.50 mm in thickness. To control the thickness of the coating composition applied between both substrates, glass beads are used as spacers having a diameter of 100 to 200 microns. Tensile lapshear (TLS) tests were performed at room temperature based on EN 1465:2009 (German version) Based on Adhesives—Determination of tensile lap-shear strength of bonded assemblies.

The bond overlapping area for each stated substrate was 2.5 cm×1.0 cm with a bond thickness of 0.1 cm (40 m). The applied adhesive compositions were cured in the overlapping region by first leaving in ambient conditions for 1 hour and subsequently applying a temperature of 80° C. for 30 minutes. The bonded structures were then stored at room temperature for 24 hours prior to initial tensile testing or storing them in a climate chamber for accelerated ageing studies at 65° C. and 90% relative humidity.

Tensile lapshear strength values were collected after said 24 hours storage period both prior and subsequent application of a constant potential of 50 V across the adhesive layer for a duration of 30 minutes, and after storage in the climate chamber at 65° C. and 90% relative humidity, respectively. The results are documented in Table 14 herein below.

TABLE 14

| | Initial | | 1 Week Storage | | 3 Weeks Storage | |
|---|---|---|---|---|---|---|
| | | Shear | | Shear | | Shear |
| | Shear | Strength | Shear | Strength | Shear | Strength |
| | Strength | (MPa) | Strength | (MPa) | Strength | (MPa) |
| Adhesive | (MPa) | 50 V, | (MPa) | 50 V, | (MPa) | 50 V, |
| composition | 0 V | 30 min | 0 V | 30 min | 0 V | 30 min |
| R1 | 17.02 ± | | 27.34 ± | | 20.89 ± | |
| | 1.59 | | 0.75 | | 0.39 | |
| Comp. 10 | 21.65 ± | 7.55 ± | 22.81 ± | 5.46 ± | 18.23 ± | 6.54 ± |
| | 0.27 | 0.57 | 0.18 | 0.30 | 1.30 | 0.56 |
| Comp. 11 | 18.72 ± | 1.48 ± | 20.51 ± | 4.32 ± | 17.02 ± | 5.91 ± |
| | 0.72 | 0.25 | 0.10 | 0.63 | 0.31 | 0.51 |
| Comp. 12 | 17.54 ± | 1.70 ± | 18.21 ± | 4.21 ± | 15.27 ± | 5.00 ± |
| | 0.34 | 1.20 | 0.60 | 0.44 | 0.66 | 0.50 |
| Comp. 13 | 15.10 ± | 0.49 ± | 15.41 ± | 3.48 ± | 13.20 ± | 4.53 ± |
| | 0.39 | 0.41 | 0.42 | 0.24 | 0.90 | 0.47 |

The reference composition R1 shows a strong increase in lapshear strength values after 1 week storage at 65° C. and 90% relative humidity, but overall, after 3 weeks storage at 65° C. and 90% relative humidity, we only see a slight increase in initial lapshear strength.

With increasing Cyphos IL 109 content, we see a gradual decrease in the initial lapshear strength, from more than 20 MPa (composition 10) down to 15 MPa composition 13). In all the compositions, we also observe the increase in lapshear strength after storage for 1 week at 65° C. and 90% relative humidity, but the increase becomes less for increasing Cyphos IL 109 content. Finally, all compositions also show a subsequent decrease in lapshear strength after 3 weeks of storage at 65° C. and 90% relative humidity. Overall, the decrease in lapshear strength after 3 weeks of storage at 65° C. and 90% relative humidity is small compared to the initial values, meaning that all compositions are very stable after storage at 65° C. and 90% relative humidity. Finally, the electrochemical delamination performance is the worst for composition 10 with 4.26 wt % of Cyphos IL 109. Nevertheless, the drop in lapshear strength is still above 50%, much better compared to the systems using MMA as acrylic monomer. A Cyphos IL 109 content higher than 4.26 wt % shows an excellent delamination performance but upon storage at 65° C. and 90% relative humidity, a decrease in performance is observed, but the final delamination performance remains above 50%, and thus much better compared to the systems using MMA as acrylic monomer.

In view of the foregoing description and examples, it will be apparent to those skilled in the art that equivalent modifications thereof can be made without departing from the scope of the appended claims.

What is claimed is:

1. A curable and debondable two-part adhesive composition comprising:
a first part (A) comprising:
(meth)acrylate monomer;
co-polymerizable acid; and,
an electrolyte; and,
a second part (B) comprising:
a first curing agent for the monomers of said first part;
a second curing agent for the monomers of said first part;
a wax; and,
a solubilizer,
wherein said two-part (2K) adhesive composition further comprises:
a toughener;
an oxygen scavenger; and,
a rheology control agent;
further wherein said two-part (2K) adhesive composition is characterized in that said electrolyte comprises or consists of at least one salt in accordance with Formula (I) or Formula (II): 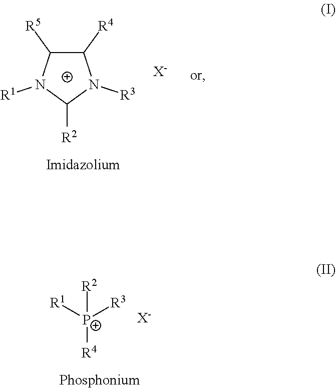
wherein: R¹, R², R³, R⁴ and R⁵ are independently selected from hydrogen, C₁-C₁₈ alkyl, C₃-C₁₈ cycloalkyl, C₆-C₁₈ aryl, C₇-C₂₄ aralkyl, C₂-C₂₀ alkenyl, —C(O)R^{q}, —C(O)OH, —CN or —NO₂; and, R^{q} is C₁-C₆ alkyl; and, X⁻ is a counter anion selected from the group consisting of: 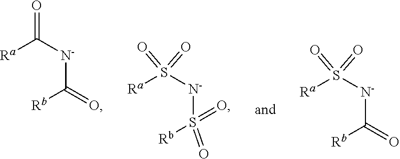
in which formulae R^{a} and R^{b} are independently selected from hydrogen, C₁-C₁₂ alkyl, C₅-C₁₂ cycloalkyl, C₅-C₁₂ heterocycloalkyl, C₆-C₁₈ aryl or C₅-C₁₈ heteroaryl.

2. The curable and debondable two-part adhesive composition according to claim 1, wherein said (meth)acrylate monomer is selected from the group consisting of methyl (meth)acrylate, ethyl (meth)acrylate, n-propyl (meth)acrylate, isopropyl (meth)acrylate, n-butyl(meth)acrylate, isobutyl (meth)acrylate, tert-butyl (meth)acrylate, n-pentyl (meth)acrylate, n-hexyl (meth)acrylate, cyclohexyl (meth)acrylate, n-heptyl (meth)acrylate, n-octyl(meth)acrylate, 2-ethylhexyl-(meth)acrylate, nonyl (meth) acrylate, decyl (meth)acrylate, dodecyl (meth)acrylate, phenyl (meth)acrylate, tolyl (meth)acrylate, benzyl (meth)acrylate, 2-methoxyethyl (meth)acrylate, 3-methoxybutyl (meth)acrylate, 2-hydroxyethyl (meth)acrylate, 2-hydroxypropyl(meth)acrylate, stearyl(meth)acrylate, glycidyl (meth)acrylate, isobornyl (meth)acrylate, 2-aminoethyl (meth)acrylate, y-(meth)acryloyloxypropyl trimethoxysilane, (meth)acrylic acid-ethylene oxide adduct, trifluoromethylmethyl (meth)acrylate, 2-trifluoromethylethyl (meth)acrylate, 2-perfluoro ethylethyl (meth)acrylate, 2-perfluoroethyl-2-perfluorobutylethyl (meth)acrylate, 2-perfluoroethyl (meth)acrylate, perfluoromethyl (meth)acrylate, diperfluoromethylmethyl (meth)acrylate, 2-perfluoromethyl-2-perfluoroethylmethyl (meth)acrylate, 2-perfluorohexylethyl (meth)acrylate, 2-perfluorodecylethyl (meth)acrylate, 2-perfluorohexadecylethyl (meth)acrylate, ethoxylated trimethylolpropane triacrylate, trimethylol propane trimethacrylate, dipentaerythritol monohydroxypentacrylate, pentaerythritol triacrylate, ethoxylated trimethylolpropane triacrylate, 1,6-hexanedioldiacrylate, neopentyl glycoldiacrylate, pentaerythritol tetraacrylate,1,2-butylene glycoldiacrylate, trimethylopropane ethoxylate tri(meth)acrylate, glyceryl propoxylate tri(meth) acrylate, trimethylolpropane tri(meth)acrylate, dipentaerythritol monohydroxy penta(meth)acrylate, tripropylene glycol di(meth)acrylate, neopentylglycol propoxylate di(meth)acrylate, 1,4-butanediol di(meth)acrylate, polyethyleneglycol di(meth)acrylate, triethyleneglycol di(meth)acrylate, butylene glycol di(meth)acrylate, ethoxylated bisphenol A di(meth)acrylate and mixtures thereof.

3. The curable and debondable two-part adhesive composition according to claim 1, wherein said (meth)acrylate monomer component is present in an amount of from 20 to 80% by weight of the total weight of the first part.

4. The curable and debondable two-part adhesive composition according to claim 1, wherein said co-polymerizable acid is selected from the group consisting of methacrylic acid, acrylic acid, itaconic acid, maleic acid, aconitic acid, crotonic acid, fumaric acid and mixtures thereof.

5. The curable and debondable two-part adhesive composition according to claim 1, wherein said copolymerisable acid is present in an amount of from 0.5 to 20% by weight of the total weight of the first part.

6. The curable and debondable two-part adhesive composition according to claim 1, wherein said electrolyte is selected from the group consisting of: 1-methylimidazolium bis(trifluoromethylsulfonyl)imide; 3-methylimidazolium bis(trifluoromethylsulfonyl) imide; 1-ethyl-3-methylimidazolium bis(trifluoromethylsulfonyl)imide; 1-propyl-3-methylimidazolium bis(trifluoromethylsulfonyl)imide; 1-butyl-3-methylimidazolium bis(trifluoromethylsulfonyl) imide; 1-butyl-2,3-dimethylimidazolium bis(trifluoromethylsulfonyl)imide; 1-hexyl-3-methylimidazolium bis(trifluoromethylsulfonyl)imide; 1-octyl-3-methylimidazolium bis(trifluoromethylsulfonyl)imide; 1-methyl-3-octylimidazolium bis(trifluoromethylsulfonyl) imide; 1-decyl-3-methylimidazolium bis(trifluoromethylsulfonyl)imide; 1-dodecyl-3-methylimidazolium bis(trifluoromethylsulfonyl)imide; tetraethylphosphonium bis(trifluoromethylsulfonyl)imide; tetrabutylphosphonium bis(trifluoromethylsulfonyl)imide; tridecyl(tetradecyl)phosphonium bis(trifluoromethylsulfonyl)imide; trihexyltetradecylphosphonium bis(trifluoromethylsulfonyl)amide; and, mixtures thereof.

7. The curable and debondable two-part adhesive composition according to claim 1, wherein said electrolyte is present in an amount of from 0.5 to 20% by weight of the total weight of the first part.

8. The curable and debondable two-part adhesive composition according to claim 1, wherein said first curing agent is a peroxide curing agent, said peroxide curing agent preferably being selected from the group consisting of tert-butyl peroxide, tert-butyl perbenzoate, cumene hydroperoxide, tert-butyl peroxybenzoate, diacetyl peroxide, benzoyl peroxide, tert-butyl peracetate, lauryl peroxide and mixtures thereof.

9. The curable and debondable two-part adhesive composition according to claim 1, wherein said first curing agent is present in an amount of from 5 to 40% by weight of the total weight of the second part.

10. The curable and debondable two-part adhesive composition according to claim 1, wherein said second curing agent is a metal compound selected from salts and complexes of iron, copper, cobalt, vanadium and manganese.

11. The curable and debondable two-part adhesive composition according to claim 1, wherein said second curing agent is present in an amount of from 0.01 to 2% by weight of the total weight of the second part.

12. The curable and debondable two-part adhesive composition according to claim 1, wherein said solubilizer is polyethylene glycol or epoxy resin selected from the group consisting of cycloaliphatic epoxides, epoxy novolac resins, bisphenol-A-epoxy resins, bisphenol-F-epoxy resins, bisphenol-A epichlorohydrin based epoxy resins, alkyl epoxides, limonene dioxides, polyepoxides and mixtures thereof.

13. The curable and debondable two-part adhesive composition according to claim 1, wherein said solubilizer is present in an amount of from 20 to 60% by weight of the total weight of the second part.

14. The curable and debondable two-part adhesive composition according to claim 1, wherein said toughener is present in an amount of from 5 to 40% by weight of the total weight of the composition.

15. The curable and debondable two-part adhesive composition according to claim 1, wherein said first (A) and second (B) parts are combined at a ratio by weight A:B of from 20:1 to 1:1.

16. A bonded structure comprising:
a first material layer having an electrically conductive surface; and,
a second material layer having an electrically conductive surface;
wherein the cured debondable two-part adhesive composition according to claim 1 is disposed between the first and second material layers.

17. A method of debonding said bonded structure according to claim 16, the method comprising the steps of:
i) applying a voltage across both surfaces to form an anodic interface and a cathodic interface; and,
ii) debonding the surfaces.

18. A method according to the claim 17, wherein the voltage applied in step i) is from 0.5 to 100 V and it is preferably applied for a duration of from 1 second to 60 minutes.
